(19) United States
(12) Patent Application Publication
(10) Pub. No.: US 2023/0029109 A1
(43) Pub. Date: Jan. 26, 2023

(54) TECHNIQUES FOR MULTI-LAYER LIQUID CRYSTAL ACTIVE LIGHT MODULATION

(71) Applicant: META PLATFORMS TECHNOLOGIES, LLC, Menlo Park, CA (US)

(72) Inventors: Zhimin SHI, Bellevue, WA (US); Yongdan HU, Bothell, WA (US); Changwon JANG, Seattle, WA (US)

(21) Appl. No.: 17/381,891

(22) Filed: Jul. 21, 2021

(51) Int. Cl. G02F 1/1335; G02F 1/1343; G02B 27/01; G02B 27/00; G03H 1/22

(52) U.S. Cl. CPC G02F 1/133553; G02F 1/133526; G02F 1/133528; G02F 1/134309; G02B 27/0172; G02B 27/0093; G03H 1/2294; G02B 2027/0174; G02B 2027/0178

(57) ABSTRACT

Various embodiments set forth optical patterning systems. In some embodiments, an optical patterning system includes multiple liquid crystal (LC) layers and a substrate including circuitry that is connected to each of the LC layers. Each LC layer is independently addressable, via connections to the circuitry in the substrate, to modulate a different degree of freedom (DOF) of light, such as an amplitude, a phase, a distinct polarization component, or an amplitude or a phase of a polarization component of the light. In addition, each LC layer can be configured to operate in a non-resonant mode, in which light passes through the LC layer a single time, or in a resonant mode, in which light bounces back and forth between reflective layers multiple times to enhance the interaction with the LC layer.

### BACKGROUND

### Field of the Various Embodiments

Embodiments of this disclosure relate generally to optical systems and, more specifically, to techniques for multi-layer liquid crystal active light modulation.

### Description of the Related Art

Holography uses light interference patterns to form three-dimensional (3D) images. A traditional hologram is a holographic interference pattern of light from a real object and light from a coherent light source. Computer-generated holography applies various algorithms to simulate the holographic interference patterns of traditional holograms. A computer-generated hologram can be presented by using a spatial light modulator (SLM) to encode light from a light source with the pattern output by such an algorithm.

SLMs impose spatially varying modulation on light beams. Conventional SLMs modulate either the amplitude or phase of a light beam. Oftentimes, computer-generated holography requires both modulation of multiple degrees of freedom (DOFs) of a light beam, such as modulation of both amplitude and phase of the light beam. One approach for modulating multiple DOFs of a light beam uses an optical relay-imaging system to image the plane of one SLM that is used to modulate one DOF of a light beam to the plane of another SLM that is used to modulate another DOF of the light beam. Oftentimes, such a cascaded series of SLMs that includes an optical relay-imaging system is relatively large in size, which can be unsuitable for certain applications such as head-mounted displays.

Another approach for modulating multiple DOFs of a light beam is to laminate together multiple SLMs that modulate different DOFs. Typically, each of the multiple SLMs includes a relatively thick substrate that is constructed from, e.g., silicon or glass, and provides rigidity to the SLM. Oftentimes, a system including multiple laminated SLMs, each of which includes a substrate, can be relatively large in size and unsuitable for certain applications, such as head-mounted displays. Further, cells within the multiple SLMs must be aligned with each other during the lamination process, which can be difficult to achieve, particularly when the cells are relatively small in size (e.g., cells having a period of one to a few microns). In addition, liquid crystal layers in laminated SLMs are oftentimes relatively far apart from each other, which can introduce light propagation effects, particularly for small-pitch devices where the propagation of light is beyond the geometrical ray optics limit.

As the foregoing illustrates, what is needed in the art are more effective techniques for modulating multiple DOFs of a light beam.

### SUMMARY

One embodiment of the present disclosure sets forth an optical patterning system that includes a plurality of liquid crystal layers and a substrate that includes circuitry. Each liquid crystal layer included in the plurality of liquid crystal layers is controllable to modulate a different degree of freedom of light. In addition, each liquid crystal layer included in the plurality of liquid crystal layers is connected to the circuitry included in the substrate.

Another embodiment of the present disclosure sets forth a method for fabricating an optical patterning system. The method includes fabricating a first stack that includes a substrate, circuitry, and at least one of a high-reflection layer, a partial-reflection layer, or an anti-reflection layer, etching through the first stack, and depositing a first layer that includes electronic vias. The method further includes fabricating at least one cell above the first stack, where each cell includes a plurality of layers that are filled with sacrificial material, etching through the at least one cell, and depositing a second layer that includes electronic vias. The method also includes fabricating a third layer that includes one or more electrodes above the at least one cell. In addition, the method includes etching away the sacrificial material within the plurality of layers, and filling the plurality of layers with liquid crystals.

Another embodiment of the present disclosure sets forth a computer-implemented method for modulating light. The method includes determining states of a plurality of cells of an optical patterning system for at least one point in time. The method further includes driving each cell included in the plurality of cells based on a corresponding state, where driving the section includes: driving, via a first connection to circuitry in a substrate, a section of a first liquid crystal layer to modulate at least a first degree of freedom of light, and driving, via a second connection to the circuitry in the substrate, a section of a second liquid crystal layer to modulate at least a second degree of freedom of light. In addition, the method includes projecting a light beam that is incident on the plurality of sections.

Other embodiments of the present disclosure include, without limitation, a computer-readable medium including instructions for performing one or more aspects of the disclosed techniques as well as a computing device for performing one or more aspects of the disclosed techniques.

One advantage of the optical patterning systems disclosed herein is that the systems can be more compact in size relative to conventional systems that include multiple SLMs relayed via an optical relay-imaging system or that laminate together multiple SLMs that include different substrates. In the optical patterning systems disclosed herein, multiple liquid crystal layers can be placed relatively close to one another, which reduces propagation effects of light passing through the optical patterning systems. Further, techniques are disclosed for achieving a relatively high fill factor by placing non-optically transparent electronic control circuits underneath the reflective materials in a reflective optical patterning system, and by using microlens arrays in reflective and transmissive optical patterning systems. In addition, some embodiments of the optical patterning systems disclosed herein can be fabricated using conventional micro-fabrication processes that are scalable at the wafer level, and no mutual alignment between layers of SLMs that are laminated together is required. These technical advantages represent one or more technological advancements over prior art approaches.

### BRIEF DESCRIPTION OF THE DRAWINGS

So that the manner in which the above recited features of the various embodiments can be understood in detail, a more particular description of the disclosed concepts, briefly summarized above, may be had by reference to various embodiments, some of which are illustrated in the appended drawings. It is to be noted, however, that the appended drawings illustrate only typical embodiments of the disclosed concepts and are therefore not to be considered limiting of scope in any way, and that there are other equally effective embodiments.

FIG. 1A is a diagram of a near eye display (NED), according to various embodiments.

FIG. 1B is a cross section of the front rigid body of the embodiments of the NED illustrated in FIG. 1A.

FIG. 2A is a diagram of a head-mounted display (HMD) implemented as a NED, according to various embodiments.

FIG. 2B is a cross-section view of the HMD of FIG. 2A implemented as a near eye display, according to various embodiments.

FIG. 3 is a block diagram of a NED system, according to various embodiments.

FIG. 4 is a schematic diagram illustrating a cross-section view of a reflective optical patterning system, according to various embodiments.

FIG. 5 is a schematic diagram illustrating a cross-section view of a transmissive optical patterning system, according to various embodiments.

FIG. 6 is a schematic diagram illustrating a cross-section view of an exemplar liquid crystal on silicon (LCOS) optical patterning system, according to various embodiments.

FIG. 7 is a schematic diagram illustrating a cross-section view of an exemplar LCOS optical patterning system, according to other various embodiments.

FIG. 8 is a schematic diagram illustrating a cross-section view of an exemplar LCOS optical patterning system, according to other various embodiments.

FIG. 9 is a schematic diagram illustrating a cross-section view of an exemplar LCOS optical patterning system, according to other various embodiments.

FIG. 10 is a schematic diagram illustrating a cross-section view of an exemplar transmissive optical patterning system, according to various embodiments.

FIG. 11 is a schematic diagram illustrating a cross-section view of an exemplar transmissive optical patterning system, according to other various embodiments.

FIG. 12 is a schematic diagram illustrating a cross-section view of an exemplar transmissive optical patterning system, according to other various embodiments.

FIG. 13 is a schematic diagram illustrating a cross-section view of an exemplar transmissive optical patterning system, according to other various embodiments.

FIG. 14 is a schematic diagram illustrating a cross-section view of an exemplar transmissive optical patterning system, according to other various embodiments.

FIG. 15 is a schematic diagram illustrating a portion of a virtual reality optical system that includes an optical patterning system, according to various embodiments.

FIG. 16 is a schematic diagram illustrating a portion of another virtual reality optical system that includes an optical patterning system, according to various embodiments.

FIG. 17 is a schematic diagram illustrating a portion of an augmented reality optical system that includes an optical patterning system, according to various embodiments.

FIG. 18 is a flow diagram illustrating a method for modulating a beam of light, according to various embodiments.

FIG. 19 illustrates an example approach for fabricating a dual-layer LCOS optical patterning system, according to various embodiments.

FIG. 20 illustrates an example approach for fabricating a dual-layer transmissive optical patterning system, according to various embodiments.

FIG. 21 is a flow diagram illustrating a method for fabricating an optical patterning system, according to various embodiments.

### DETAILED DESCRIPTION

In the following description, numerous specific details are set forth to provide a more thorough understanding of the various embodiments. However, it is apparent to one of skilled in the art that the disclosed concepts may be practiced without one or more of these specific details.

### Configuration Overview

One or more embodiments disclosed herein relate to optical patterning systems. In some embodiments, an optical patterning system includes multiple liquid crystal (LC) layers and a substrate including circuitry that is connected to each of the LC layers. Each LC layer is independently addressable, via connections to the circuitry in the substrate, to modulate a different degree of freedom (DOF) of light, such as an amplitude, a phase, a polarization component, an amplitude or a phase of a polarization component, or a direction of propagation of the light. In addition, each LC layer can be configured to operate in a non-resonant mode, in which light passes through the LC layer a single time, or in a resonant mode, in which light bounces back and forth between reflective layers multiple times to enhance the interaction with the LC layer. The optical patterning systems disclosed herein may be reflective, transmissive, or transflective. Further, the optical patterning systems may be used as spatial light modulators and in holography (e.g., polarization volume holograms, point source holograms, Fourier transform holograms, or other computer-generated holograms), among other things.

Embodiments of the disclosure may also include or be implemented in conjunction with an artificial reality system. Artificial reality is a form of reality that has been adjusted in some manner before presentation to a user, which may include, for example, a virtual reality (VR) system, an augmented reality (AR) system, a mixed reality (MR) system, a hybrid reality system, or some combination and/or derivatives thereof. Artificial reality content may include, without limitation, completely generated content or generated content combined with captured (e.g., real-world) content. The artificial reality content may include, without limitation, video, audio, haptic feedback, or some combination thereof. The artificial reality content may be presented in a single channel or in multiple channels (such as stereo video that produces a three-dimensional effect to the viewer). Additionally, in some embodiments, artificial reality systems may also be associated with applications, products, accessories, services, or some combination thereof, that are used to, e.g., create content in an artificial reality system and/or are otherwise used in (e.g., perform activities in) an artificial reality system. The artificial reality system may be implemented on various platforms, including a head-mounted display (HMD) connected to a host computer system, a standalone HMD, a mobile device or computing system, or any other hardware platform capable of providing artificial reality content to one or more viewers.

### System Overview

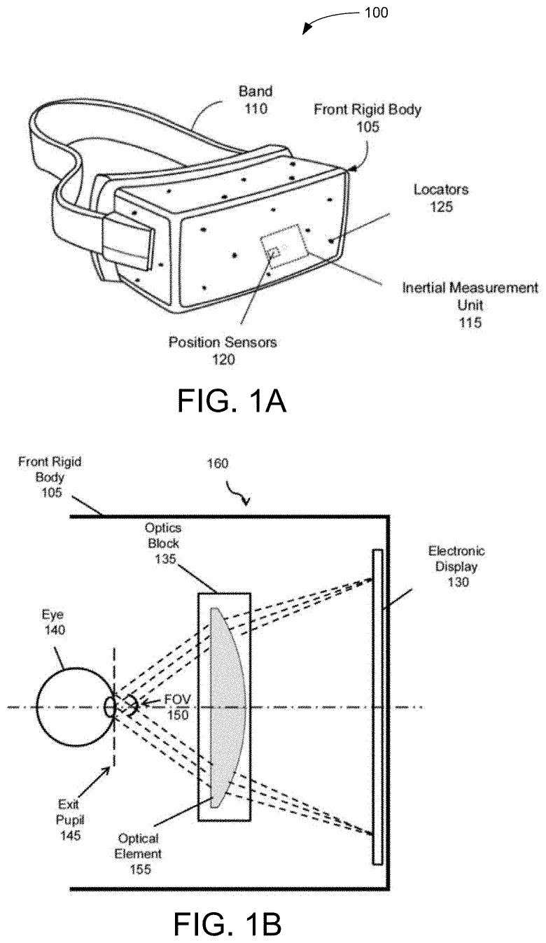

FIG. 1A is a wire diagram of a near eye display (NED) 100, according to various embodiments. Although NEDs and head mounted displays (HMDs) are disclosed herein as reference examples, display devices that include the optical patterning systems disclosed herein also be configured for placement in proximity of an eye or eyes of the user at a fixed location, without being head-mounted (e.g., the display device may be mounted in a vehicle, such as a car or an airplane, for placement in front of an eye or eyes of the user).

As shown, the NED 100 includes a front rigid body 105 and a band 110. The front rigid body 105 includes one or more electronic display elements of an electronic display (not shown), an inertial measurement unit (IMU) 115, one or more position sensors 120, and locators 125. As illustrated in FIG. 1A, position sensors 120 are located within the IMU 115, and neither the IMU 115 nor the position sensors 120 are visible to the user. In various embodiments, where the NED 100 acts as an AR or MR device, portions of the NED 100 and/or its internal components are at least partially transparent.

FIG. 1B is a cross section 160 of the front rigid body 105 of the embodiments of the NED 100 illustrated in FIG. 1A. As shown, the front rigid body 105 includes an electronic display 130 and an optics block 135 that together provide image light to an exit pupil 145. The exit pupil 145 is the location of the front rigid body 105 where a user's eye 140 may be positioned. For purposes of illustration, FIG. 1B illustrates a cross section 160 associated with a single eye 140, but another optics block, separate from the optics block 135, may provide altered image light to another eye of the user. Additionally, the NED 100 includes an eye tracking system (not shown in FIG. 1B). The eye tracking system may include one or more sources that illuminate one or both eyes of the user. The eye tracking system may also include one or more cameras that capture images of one or both eyes of the user to track the positions of the eyes.

The electronic display 130 displays images to the user. In various embodiments, the electronic display 130 may comprise a single electronic display or multiple electronic displays (e.g., a display for each eye of a user). Examples of the electronic display 130 include: a liquid crystal display (LCD), an organic light emitting diode (OLED) display, an active-matrix organic light-emitting diode display (AMOLED), a QOLED, a QLED, some other display, or some combination thereof.

The optics block 135 adjusts an orientation of image light emitted from the electronic display 130 such that the electronic display 130 appears at particular virtual image distances from the user. The optics block 135 is configured to receive image light emitted from the electronic display 130 and direct the image light to an eye-box associated with the exit pupil 145. The image light directed to the eye-box forms an image at a retina of eye 140. The eye-box is a region defining how much the eye 140 moves up/down/left/right from without significant degradation in the image quality. In the illustration of FIG. 1B, a field of view (FOV) 150 is the extent of the observable world that is seen by the eye 140 at any given moment.

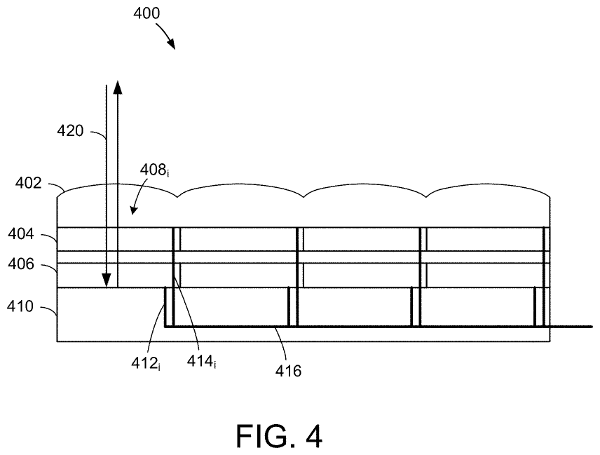

Additionally, in some embodiments, the optics block 135 magnifies received light, corrects optical errors associated with the image light, and presents the corrected image light to the eye 140. The optics block 135 may include one or more optical elements 155 in optical series. An optical element 155 may be an aperture, a Fresnel lens, a convex lens, a concave lens, a filter, a waveguide, a PBP lens or grating, a color-selective filter, a waveplate, a C-plate, a spatial light modulator, or any other suitable optical element 155 that affects the image light. Moreover, the optics block 135 may include combinations of different optical elements. One or more of the optical elements in the optics block 135 may have one or more coatings, such as anti-reflective coatings. In some embodiments, the optics block 135 may include one or more of the optical patterning systems discussed in detail below in conjunction with FIGS. 4-14.

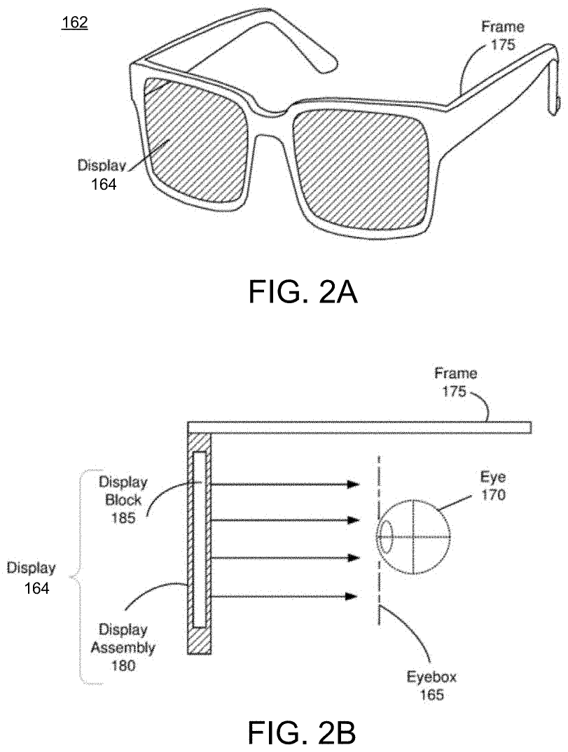

FIG. 2A is a diagram of an HMD 162 implemented as a NED, according to various embodiments. As shown, the HMD 162 is in the form of a pair of augmented reality glasses. The HMD 162 presents computer-generated media to a user and augments views of a physical, real-world environment with the computer-generated media. Examples of computer-generated media presented by the HMD 162 include one or more images, video, audio, or some combination thereof. In some embodiments, audio is presented via an external device (e.g., speakers and headphones) that receives audio information from the HMD 162, a console (not shown), or both, and presents audio data based on audio information. In some embodiments, the HMD 162 may be modified to also operate as a virtual reality (VR) HMD, a mixed reality (MR) HMD, or some combination thereof. The HMD 162 includes a frame 175 and a display 164. As shown, the frame 175 mounts the near eye display to the user's head, while the display 164 provides image light to the user. The display 164 may be customized to a variety of shapes and sizes to conform to different styles of eyeglass frames.

FIG. 2B is a cross-section view of the HMD 162 of FIG. 2A implemented as a NED, according to various embodiments. This view includes frame 175, display 164 (which comprises a display assembly 180 and a display block 185), and eye 170. The display assembly 180 supplies image light to the eye 170. The display assembly 180 houses display block 185, which, in different embodiments, encloses the different types of imaging optics and redirection structures. For purposes of illustration, FIG. 2B shows the cross section associated with a single display block 185 and a single eye 170, but in alternative embodiments not shown, another display block, which is separate from display block 185 shown in FIG. 2B, provides image light to another eye of the user.

The display block 185, as illustrated, is configured to combine light from a local area with light from a computer generated image to form an augmented scene. The display block 185 is also configured to provide the augmented scene to the eyebox 165 corresponding to a location of the user's eye 170. The display block 185 may include, for example, a waveguide display, a focusing assembly, a compensation assembly, or some combination thereof.

HMD 162 may include one or more other optical elements between the display block 185 and the eye 170. The optical elements may act to, for example, correct aberrations in image light emitted from the display block 185, magnify image light emitted from the display block 185, some other optical adjustment of image light emitted from the display block 185, or some combination thereof. The example for optical elements may include an aperture, a Fresnel lens, a convex lens, a concave lens, a filter, or any other suitable optical element that affects image light. In some embodiments, the optical elements may include one or more of the optical patterning systems discussed in detail below in conjunction with FIGS. 4-14. The display block 185 may also comprise one or more materials (e.g., plastic, glass, etc.) with one or more refractive indices that effectively minimize the weight and widen a field of view of the HMD 162.

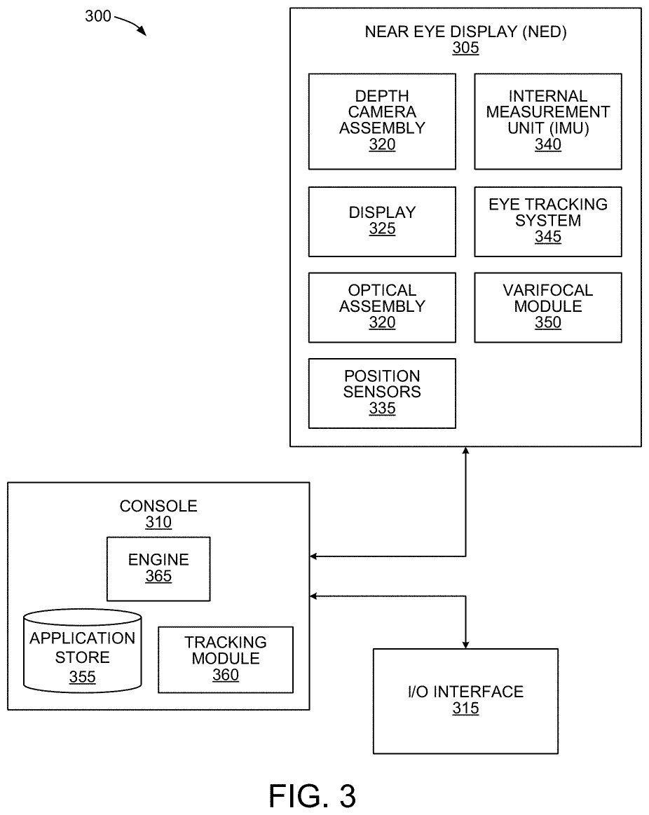

FIG. 3 is a block diagram of an embodiment of a near eye display system 300 in which a console 310 operates. In some embodiments, the NED system 300 corresponds to the NED 100 or the HMD 162. The NED system 300 may operate in a virtual reality (VR) system environment, an augmented reality (AR) system environment, a mixed reality (MR) system environment, or some combination thereof. The NED system 300 shown in FIG. 3 comprises a NED 305 and an input/output (I/O) interface 315 that is coupled to the console 310.

While FIG. 3 shows an example NED system 300 including one NED 305 and one I/O interface 315, in other embodiments any number of these components may be included in the NED system 300. For example, there may be multiple NEDs 305 that each has an associated I/O interface 315, where each NED 305 and I/O interface 315 communicates with the console 310. In alternative configurations, different and/or additional components may be included in the NED system 300. Additionally, various components included within the NED 305, the console 310, and the I/O interface 315 may be distributed in a different manner than is described in conjunction with FIG. 3 in some embodiments. For example, some or all of the functionality of the console 310 may be provided by the NED 305.

The NED 305 may be a head-mounted display that presents content to a user. The content may include virtual and/or augmented views of a physical, real-world environment including computer-generated elements (e.g., two-dimensional or three-dimensional images, two-dimensional or three-dimensional video, sound, etc.). In some embodiments, the NED 305 may also present audio content to a user. The NED 305 and/or the console 310 may transmit the audio content to an external device via the I/O interface 315. The external device may include various forms of speaker systems and/or headphones. In various embodiments, the audio content is synchronized with visual content being displayed by the NED 305.

The NED 305 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other.

As shown in FIG. 3, the NED 305 may include a depth camera assembly (DCA) 320, a display 325, an optical assembly 330, one or more position sensors 335, an inertial measurement unit (IMU) 340, an eye tracking system 345, and a varifocal module 350. In some embodiments, the display 325 and the optical assembly 330 can be integrated together into a projection assembly. Various embodiments of the NED 305 may have additional, fewer, or different components than those listed above. Additionally, the functionality of each component may be partially or completely encompassed by the functionality of one or more other components in various embodiments.

The DCA 320 captures sensor data describing depth information of an area surrounding the NED 305. The sensor data may be generated by one or a combination of depth imaging techniques, such as triangulation, structured light imaging, time-of-flight imaging, laser scan, and so forth. The DCA 320 can compute various depth properties of the area surrounding the NED 305 using the sensor data. Additionally or alternatively, the DCA 320 may transmit the sensor data to the console 310 for processing.

The DCA 320 includes an illumination source, an imaging device, and a controller. The illumination source emits light onto an area surrounding the NED 305. In an embodiment, the emitted light is structured light. The illumination source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (such as edge emitters), inorganic or organic light-emitting diodes (LEDs), a vertical-cavity surface-emitting laser (VCSEL), or some other source. In some embodiments, a single emitter or a plurality of emitters in the illumination source can emit light having a structured light pattern. The imaging device captures ambient light in the environment surrounding NED 305, in addition to light reflected off of objects in the environment that is generated by the plurality of emitters. In various embodiments, the imaging device may be an infrared camera or a camera configured to operate in a visible spectrum. The controller coordinates how the illumination source emits light and how the imaging device captures light. For example, the controller may determine a brightness of the emitted light. In some embodiments, the controller also analyzes detected light to detect objects in the environment and position information related to those objects.

The display 325 displays two-dimensional or three-dimensional images to the user in accordance with pixel data received from the console 310. In various embodiments, the display 325 comprises a single display or multiple displays (e.g., separate displays for each eye of a user). In some embodiments, the display 325 comprises a single or multiple waveguide displays. Light can be coupled into the single or multiple waveguide displays via, e.g., a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, other types of displays, a scanner, a one-dimensional array, and so forth. In addition, combinations of the display types may be incorporated in display 325 and used separately, in parallel, and/or in combination.

The optical assembly 330 magnifies image light received from the display 325, corrects optical errors associated with the image light, and presents the corrected image light to a user of the NED 305. The optical assembly 330 includes a plurality of optical elements. For example, one or more of the following optical elements may be included in the optical assembly 330: an aperture, a Fresnel lens, a convex lens, a concave lens, a filter, a reflecting surface, or any other suitable optical element that deflects, reflects, refracts, and/or in some way alters image light. Moreover, the optical assembly 330 may include combinations of different optical elements. In some embodiments, one or more of the optical elements in the optical assembly 330 may have one or more coatings, such as partially reflective or antireflective coatings. The optical assembly 330 can be integrated into a projection assembly, e.g., a projection assembly. In one embodiment, the optical assembly 330 includes the optics block 155.

In operation, the optical assembly 330 magnifies and focuses image light generated by the display 325. In so doing, the optical assembly 330 enables the display 325 to be physically smaller, weigh less, and consume less power than displays that do not use the optical assembly 330. Additionally, magnification may increase the field of view of the content presented by the display 325. For example, in some embodiments, the field of view of the displayed content partially or completely uses a user's field of view. For example, the field of view of a displayed image may meet or exceed 310 degrees. In various embodiments, the amount of magnification may be adjusted by adding or removing optical elements.

In some embodiments, the optical assembly 330 may be designed to correct one or more types of optical errors. Examples of optical errors include barrel or pincushion distortions, longitudinal chromatic aberrations, or transverse chromatic aberrations. Other types of optical errors may further include spherical aberrations, chromatic aberrations or errors due to the lens field curvature, astigmatisms, in addition to other types of optical errors. In some embodiments, visual content transmitted to the display 325 is pre-distorted, and the optical assembly 330 corrects the distortion as image light from the display 325 passes through various optical elements of the optical assembly 330. In some embodiments, optical elements of the optical assembly 330 are integrated into the display 325 as a projection assembly that includes at least one waveguide coupled with one or more optical elements.

The IMU 340 is an electronic device that generates data indicating a position of the NED 305 based on measurement signals received from one or more of the position sensors 335 and from depth information received from the DCA 320. In some embodiments of the NED 305, the IMU 340 may be a dedicated hardware component. In other embodiments, the IMU 340 may be a software component implemented in one or more processors.

In operation, a position sensor 335 generates one or more measurement signals in response to a motion of the NED 305. Examples of position sensors 335 include: one or more accelerometers, one or more gyroscopes, one or more magnetometers, one or more altimeters, one or more inclinometers, and/or various types of sensors for motion detection, drift detection, and/or error detection. The position sensors 335 may be located external to the IMU 340, internal to the IMU 340, or some combination thereof.

Based on the one or more measurement signals from one or more position sensors 335, the IMU 340 generates data indicating an estimated current position of the NED 305 relative to an initial position of the NED 305. For example, the position sensors 335 may include multiple accelerometers to measure translational motion (forward/back, up/down, left/right) and multiple gyroscopes to measure rotational motion (e.g., pitch, yaw, and roll). In some embodiments, the IMU 340 rapidly samples the measurement signals and calculates the estimated current position of the NED 305 from the sampled data. For example, the IMU 340 may integrate the measurement signals received from the accelerometers over time to estimate a velocity vector and integrates the velocity vector over time to determine an estimated current position of a reference point on the NED 305. Alternatively, the IMU 340 provides the sampled measurement signals to the console 310, which analyzes the sample data to determine one or more measurement errors. The console 310 may further transmit one or more of control signals and/or measurement errors to the IMU 340 to configure the IMU 340 to correct and/or reduce one or more measurement errors (e.g., drift errors). The reference point is a point that may be used to describe the position of the NED 305. The reference point may generally be defined as a point in space or a position related to a position and/or orientation of the NED 305.

In various embodiments, the IMU 340 receives one or more parameters from the console 310. The one or more parameters are used to maintain tracking of the NED 305. Based on a received parameter, the IMU 340 may adjust one or more IMU parameters (e.g., a sample rate). In some embodiments, certain parameters cause the IMU 340 to update an initial position of the reference point so that it corresponds to a next position of the reference point. Updating the initial position of the reference point as the next calibrated position of the reference point helps reduce drift errors in detecting a current position estimate of the IMU 340.

In some embodiments, the eye tracking system 345 is integrated into the NED 305. The eye-tracking system 345 may comprise one or more illumination sources and an imaging device (camera). In operation, the eye tracking system 345 generates and analyzes tracking data related to a user's eyes as the user wears the NED 305. The eye tracking system 345 may further generate eye tracking information that may comprise information about a position of the user's eye, i.e., information about an angle of an eye-gaze.

In some embodiments, the varifocal module 350 is further integrated into the NED 305. The varifocal module 350 may be communicatively coupled to the eye tracking system 345 in order to enable the varifocal module 350 to receive eye tracking information from the eye tracking system 345. The varifocal module 350 may further modify the focus of image light emitted from the display 325 based on the eye tracking information received from the eye tracking system 345. Accordingly, the varifocal module 350 can reduce vergence-accommodation conflict that may be produced as the user's eyes resolve the image light. In various embodiments, the varifocal module 350 can be interfaced (e.g., either mechanically or electrically) with at least one optical element of the optical assembly 330.

In operation, the varifocal module 350 may adjust the position and/or orientation of one or more optical elements in the optical assembly 330 in order to adjust the focus of image light propagating through the optical assembly 330. In various embodiments, the varifocal module 350 may use eye tracking information obtained from the eye tracking system 345 to determine how to adjust one or more optical elements in the optical assembly 330. In some embodiments, the varifocal module 350 may perform foveated rendering of the image light based on the eye tracking information obtained from the eye tracking system 345 in order to adjust the resolution of the image light emitted by the display 325. In this case, the varifocal module 350 configures the display 325 to display a high pixel density in a foveal region of the user's eye-gaze and a low pixel density in other regions of the user's eye-gaze.

The I/O interface 315 facilitates the transfer of action requests from a user to the console 310. In addition, the I/O interface 315 facilitates the transfer of device feedback from the console 310 to the user. An action request is a request to perform a particular action. For example, an action request may be an instruction to start or end capture of image or video data or an instruction to perform a particular action within an application, such as pausing video playback, increasing or decreasing the volume of audio playback, and so forth. In various embodiments, the I/O interface 315 may include one or more input devices. Example input devices include: a keyboard, a mouse, a game controller, a joystick, and/or any other suitable device for receiving action requests and communicating the action requests to the console 310. In some embodiments, the I/O interface 315 includes an IMU 340 that captures calibration data indicating an estimated current position of the I/O interface 315 relative to an initial position of the I/O interface 315.

In operation, the I/O interface 315 receives action requests from the user and transmits those action requests to the console 310. Responsive to receiving the action request, the console 310 performs a corresponding action. For example, responsive to receiving an action request, the console 310 may configure the I/O interface 315 to emit haptic feedback onto an arm of the user. For example, the console 315 may configure the I/O interface 315 to deliver haptic feedback to a user when an action request is received. Additionally or alternatively, the console 310 may configure the I/O interface 315 to generate haptic feedback when the console 310 performs an action, responsive to receiving an action request.

The console 310 provides content to the NED 305 for processing in accordance with information received from one or more of: the DCA 320, the NED 305, and the I/O interface 315. As shown in FIG. 3, the console 310 includes an application store 355, a tracking module 360, and an engine 365. In some embodiments, the console 310 may have additional, fewer, or different modules and/or components than those described in conjunction with FIG. 3. Similarly, the functions further described below may be distributed among components of the console 310 in a different manner than described in conjunction with FIG. 3.

The application store 355 stores one or more applications for execution by the console 310. An application is a group of instructions that, when executed by a processor, performs a particular set of functions, such as generating content for presentation to the user. For example, an application may generate content in response to receiving inputs from a user (e.g., via movement of the NED 305 as the user moves his/her head, via the I/O interface 315, etc.). Examples of applications include: gaming applications, conferencing applications, video playback applications, or other suitable applications.

The tracking module 360 calibrates the NED system 300 using one or more calibration parameters. The tracking module 360 may further adjust one or more calibration parameters to reduce error in determining a position and/or orientation of the NED 305 or the I/O interface 315. For example, the tracking module 360 may transmit a calibration parameter to the DCA 320 in order to adjust the focus of the DCA 320. Accordingly, the DCA 320 may more accurately determine positions of structured light elements reflecting off of objects in the environment. The tracking module 360 may also analyze sensor data generated by the IMU 340 in determining various calibration parameters to modify. Further, in some embodiments, if the NED 305 loses tracking of the user's eye, then the tracking module 360 may re-calibrate some or all of the components in the NED system 300. For example, if the DCA 320 loses line of sight of at least a threshold number of structured light elements projected onto the user's eye, the tracking module 360 may transmit calibration parameters to the varifocal module 350 in order to re-establish eye tracking.

The tracking module 360 tracks the movements of the NED 305 and/or of the I/O interface 315 using information from the DCA 320, the one or more position sensors 335, the IMU 340 or some combination thereof. For example, the tracking module 360 may determine a reference position of the NED 305 from a mapping of an area local to the NED 305. The tracking module 360 may generate this mapping based on information received from the NED 305 itself. The tracking module 360 may also utilize sensor data from the IMU 340 and/or depth data from the DCA 320 to determine references positions for the NED 305 and/or I/O interface 315. In various embodiments, the tracking module 360 generates an estimation and/or prediction for a subsequent position of the NED 305 and/or the I/O interface 315. The tracking module 360 may transmit the predicted subsequent position to the engine 365.

The engine 365 generates a three-dimensional mapping of the area surrounding the NED 305 (i.e., the “local area”) based on information received from the NED 305. In some embodiments, the engine 365 determines depth information for the three-dimensional mapping of the local area based on depth data received from the DCA 320 (e.g., depth information of objects in the local area). In some embodiments, the engine 365 calculates a depth and/or position of the NED 305 by using depth data generated by the DCA 320. In particular, the engine 365 may implement various techniques for calculating the depth and/or position of the NED 305, such as stereo based techniques, structured light illumination techniques, time-of-flight techniques, and so forth. In various embodiments, the engine 365 uses depth data received from the DCA 320 to update a model of the local area and to generate and/or modify media content based in part on the updated model.

The engine 365 also executes applications within the NED system 300 and receives position information, acceleration information, velocity information, predicted future positions, or some combination thereof, of the NED 305 from the tracking module 360. Based on the received information, the engine 365 determines various forms of media content to transmit to the NED 305 for presentation to the user. For example, if the received information indicates that the user has looked to the left, the engine 365 generates media content for the NED 305 that mirrors the user's movement in a virtual environment or in an environment augmenting the local area with additional media content. Accordingly, the engine 365 may generate and/or modify media content (e.g., visual and/or audio content) for presentation to the user. The engine 365 may further transmit the media content to the NED 305. Additionally, in response to receiving an action request from the I/O interface 315, the engine 365 may perform an action within an application executing on the console 310. The engine 305 may further provide feedback when the action is performed. For example, the engine 365 may configure the NED 305 to generate visual and/or audio feedback and/or the I/O interface 315 to generate haptic feedback to the user.

In some embodiments, based on the eye tracking information (e.g., orientation of the user's eye) received from the eye tracking system 345, the engine 365 determines a resolution of the media content provided to the NED 305 for presentation to the user on the display 325. The engine 365 may adjust a resolution of the visual content provided to the NED 305 by configuring the display 325 to perform foveated rendering of the visual content, based at least in part on a direction of the user's gaze received from the eye tracking system 345. The engine 365 provides the content to the NED 305 having a high resolution on the display 325 in a foveal region of the user's gaze and a low resolution in other regions, thereby reducing the power consumption of the NED 305. In addition, using foveated rendering reduces a number of computing cycles used in rendering visual content without compromising the quality of the user's visual experience. In some embodiments, the engine 365 can further use the eye tracking information to adjust a focus of the image light emitted from the display 325 in order to reduce vergence-accommodation conflicts.

### Integrated Multi-Layer Liquid Crystal Active Light Modulation

FIG. 4 is a schematic diagram illustrating a cross-section view of a reflective optical patterning system 400, according to various embodiments. As shown, the reflective optical patterning system 400 includes two-layer cells 408ᵢ (collectively referred to as cells 408 and individually referred to as a cell 408), a substrate 410 including circuitry 416 that is connected to each of the cells 408, and an optional cover that includes a microlens array 402. Any suitable number of cells 408 may be included in the optical patterning system 400. Dividers may, or may not, be included between cells in some embodiments.

As shown, each cell 408 includes a section of a liquid crystal (LC) layer 404 and a section of a LC layer 406. The sections of the LC layer 404 and the LC layer 406 are controllable to modulate two different degrees of freedom (DOFs) of light. Although two LC layers 404 and 406 are shown for illustrated herein, in other embodiments, a reflective optical patterning system can include any number of LC layers that are controllable to modulate different DOFs of light. As used herein, a DOF of light can include an amplitude, a phase, a polarization component, an amplitude or a phase of a polarization component, or a direction of propagation of the light. For example, a section of the LC layer 404 in one cell 408 could be controllable to modulate the amplitude of light that passes through the cell 408, and a section of the LC layer 406 in the cell 408 could be controllable to modulate the phase of the light that passes through the cell 408. As another example, a section of the LC layer 404 in one cell 408 could be controllable to modulate the phase and/or the amplitude of one polarization component of light (e.g., vertically polarized light) that passes through the cell 408, and a section of the LC layer 406 in the cell 408 could be controllable to modulate the phase and/or the amplitude of another polarization component of the light (e.g., horizontally polarized light) that passes through the cell 408. As a further example, a section of the LC layer 404 in one cell 408 could be controllable to modulate the phase of one polarization component of light (e.g., vertically polarized light) that passes through the cell 408, a section of the LC layer 406 in the cell 408 could be controllable to modulate the phase of another polarization component of the light (e.g., horizontally polarized light) that passes through the cell 408, and the modulated phases of the polarization components could be converted to a change in amplitude of the light via a polarizer (e.g., a 45 degree linear polarizer). As yet another example, a section of the LC layer 404 in one cell 408 could be controllable to form a grating that modulates a direction of propagation of light that passes through the cell 408, and the section of the LC layer 406 in the cell 408 could be controllable to form a grating that further modulates the direction of propagation of the light that passes through the cell 408. In such a case, the reflective optical patterning system 400 can be used in active beam steering and is discretely tunable by activating one or more of the sections of the LC layers 404 and 406.

Any technically feasible techniques may be employed to modulate the different DOFs of light within a cell 408. In some embodiments, to modulate the amplitude of light, a section of one of the LC layers 404 or 406 in a cell 408 may be driven to rotate the polarization of the light (or to not rotate the polarization) after the light has passed through a linear polarizer, and another linear polarizer that is aligned in an orthogonal direction may turn the polarization rotation into an amplitude change. In some embodiments, to modulate a phase of light, a section of one of the LC layers 404 or 406 in a cell 408 may be driven to rotate an orientation of LC molecules within a plane, or otherwise, so as to impart an optical path length delay/phase change to the light. In some embodiments, to change a direction in which light propagates, sections of the LC layers 404 or 406 in multiple cells 408 having a periodic structure may be driven to from a grating, such as a Pancharatnam-Berry phase (PBP) grating (or to not form such a grating), that diffracts the light, thereby changing a direction in which the light propagates. In some embodiments, to change a direction in which light propagates, a phase ramp may be used in conjunction with one or both of the sections of the LC layers 404 or 406 in a cell 408 that are driven to impart an optical path length delay/phase change to the light. Because a cell 408 includes a section of the LC layer 404 as well as a section of the LC layer 406, two different DOFs, such as amplitude and phase, amplitude and/or phase of different polarization components, the directions of two different polarization components, etc. of light that passes through the cell 408 can be modulated.

Although an exemplar reflective optical patterning system 400 is shown for illustratively purposes, in some embodiments, a reflective optical patterning system can have any technically feasible geometry and be spatial partitioned in any technically feasible manner. For example, in some embodiments, a reflective optical patterning system may include a screen that is partitioned into square or rectangular pixels, such as the cells 408 shown in FIG. 4. In such a case, the reflective optical patterning system could be used as, e.g., a spatial light modulator (SLM). As another example, in some embodiments, a reflective optical patterning system may have a circular shape and be partitioned into annular rings having different radii. In such a case, the reflective optical patterning system could be used as, e.g., an active LC lens with a tunable focal length (i.e., a varifocal lens) or a lens that permits independent control of two orthogonal polarization components, such as a lens that acts as a converging lens for one polarization component of light and a diverging lens for another polarization component of light. As yet another example, in some embodiments, the reflective optical patterning system may be partitioned into annular rings having different radii, and each of the rings may further be partitioned azimuthally.

As shown, the section of the LC layer 404 in each cell 408 is connected, by a corresponding via 414ᵢ (collectively referred to as vias 414 and individually referred to as a via 414) that passes through the LC layer 406 (and potentially other layers), to circuitry 416 that is buried in a substrate 410 that is not transparent. Similarly, the section of the LC layer 406 in each cell 408 is connected, by a corresponding via 412ᵢ (collectively referred to as vias 412 and individually referred to as a via 412) that may pass through one or more layers to the circuitry 416 that is included in the substrate 410 Accordingly, each section of the LC layers 404 and 406 in the cell 408 is individually addressable through corresponding electrodes and the vias connecting to the circuitry 416. In some embodiments that include more than two LC layers, sections in each LC layer may be connected to circuitry that is included in a substrate. Because the reflective optical patterning system 400 includes a single substrate 410, the optical patterning system 400 may be more compact than conventional systems in which multiple SLMs having distinct substrates are laminated together, as well as conventional systems that include an optical relay-imaging between SLMs. Further, because the electronic components (i.e., circuitry) are included in the substrate 410 on one side of the reflective optical patterning system 400, a relatively high fill factor (i.e., area that is transparent to light) can be achieved.

In some embodiments, the substrate 410 is constructed from silicon, and one or more reflective layers may be added on top of the silicon. Illustratively, light 420 that is incident on the optical patterning system 400 passes through and is modulated by the LC layers 404 and 406, after which the light is reflected back through, and further modulated by, the LC layers 404 and 406. Then, the modulated light exits the optical patterning system 400 from the same side that the light entered the optical patterning system 400.

As described, the reflective optical patterning system 400 also includes an optional cover layer that includes a microlens array 402. The microlens array 402 can be used to focus light through the LC layers 404 and 406, thereby improving performance. For example, the microlens array 402 could focus light so as to reduce the impact of discontinuities between the boundaries of neighboring pixels within the optical patterning system 400 that are being driven differently.

In some embodiments, each of the LC layers 404 and 406 operates in a non-resonant mode, in which light passes through the LC layer a single time. In other embodiments, one or both of the LC layers 404 and 406 may operate in a resonant mode, in which light bounces back and forth between a high-reflection layer and a partial-reflection layer multiple times to enhance the interaction with the LC layer, before exiting via the partial-reflection layer. As used herein, a high-reflection, partial reflection, or anti-reflection layer refers to a stack of one or more layers of patterned or unpatterned material that can collectively be used to control the reflection of light to a desired range of values. It should be understood that the multiple interactions with the LC layer as light bounces back and forth between the high-reflection layer and the partial-reflection layer in a resonant optical patterning system permits the LC layer to be thinner, and the optical patterning system to be more compact, relative to a non-resonant optical patterning system.

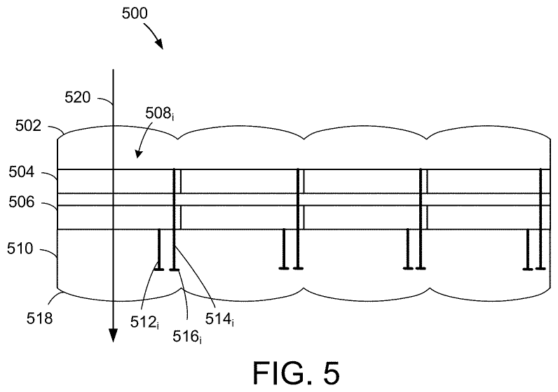

FIG. 5 is a schematic diagram illustrating a cross-section view of a transmissive optical patterning system 500, according to various embodiments. As shown, the transmissive optical patterning system 500 includes two-layer cells 508ᵢ (collectively referred to as cells 508 and individually referred to as a cell 508), a transparent substrate 510 including circuitry 516ᵢ (collectively referred to as circuitry 516 and individually referred to as a circuitry 516) that is connected to each of the cells 408, and an optional cover that includes a microlens array 402, which are similar to the two-layer cells 408, the substrate 410 including the circuitry, and the optional cover that includes a microlens array 402, described above in conjunction with FIG. 4, except the substrate 510 is constructed from an optically transparent material, such as glass or silicon dioxide, rather than an opaque material. Any suitable number of cells 508 may be included in the optical patterning system 500. Dividers may, or may not, be included between cells in some embodiments.

As shown, the circuitry 516 included in the transparent substrate 510 is connected to sections of a LC layer 504 in each of the cells 508 by vias 514ᵢ (collectively referred to as vias 514 and individually referred to as a via 514) and to sections of another LC layer 506 by vias 512ᵢ (collectively referred to as vias 512 and individually referred to as a via 512), respectively, which are similar to the vias 412 and 414 described above in conjunction with FIG. 4. Accordingly, each section of the LC layers 504 and 506 in the cell 508 is individually addressable through corresponding electrodes and the vias connecting to the circuitry 516. In order to improve the fill factor, in some embodiments, the circuitry 516 includes wires that come out from a side of the optical patterning system 500 and connect with an electronic bus. Although two LC layers are shown for illustrative purposes, in some embodiments, a transmissive optical patterning system can include any technically feasible number of LC layers that are used to modulate different DOFs of light, such as an amplitude and a phase of light, amplitudes and/or phases of different polarizations of light, phases of different polarizations of light that are converted to a change in amplitude as well via a polarizer, a direction of propagation of light, etc.

Similar to the description above in conjunction with FIG. 4, in some embodiments, the reflective optical patterning system 500 can include any technically feasible geometry and be spatial partitioned in any technically feasible manner, such as into square or rectangular pixels, into annular rings having different radii and/or azimuthal partitions, etc. Further, in some embodiments, the reflective optical patterning system 500 may be used as an SLM, a varifocal lens, or a lens that permits independent control of two orthogonal polarization components, among other things.

As shown, the transmissive optical patterning system 500 further includes cover layers including optional microlens arrays 502 and 518. The microlens arrays 502 and 518 can be used to focus light through and out of the LC layers 504 and 506, in order to improve performance. For example, the microlens arrays 502 and 518 could be used to focus light away from the circuitry 516 in the substrate 510, thereby increasing the fill factor. As another example, the microlens arrays 502 and 518 could be used to reduce the impact of discontinuities between the boundaries of neighboring pixels within the optical patterning system 500 that are being driven differently.

Illustratively, light 520 that is incident on the transmissive optical patterning system 500 from one side passes through the optical patterning system 500 and exits from another side of the optical patterning system 500. In some embodiments, each of the LC layers 504 and 506 operates in a non-resonant mode, in which light passes through the LC layer a single time. In other embodiments, one or both of the LC layers 504 and 506 may operate in a resonant mode, in which light bounces back and forth between reflective layers multiple times to enhance the interaction with the LC layer, similar to the description above in conjunction with FIG. 4.

Although described herein primarily with respect to reflective and transmissive optical patterning systems, such as the reflective optical patterning system 400 and the transmissive optical patterning system 500, in some embodiments, an optical patterning system may be transflective, i.e., partially reflective and partially transmissive. Further, in some embodiments, a reflective, transmissive, or a transflective optical patterning system (e.g., the reflective optical patterning system 400 or the transmissive optical patterning system 500) may be used to modulate multiple DOFs of a light beam emitted by a coherent light source to, e.g., generate holograms (e.g., polarization volume holograms, point source holograms, Fourier transform holograms, or other computer-generated holograms). Examples of coherent light sources include lasers and certain light emitting diodes (LEDs), superluminescent LEDs (sLEDs), microLEDs (mLED)s, or some combination thereof. For example, the reflective or transmissive optical patterning system could be used in holography, video or image projection, optical correlation, wavelength selective switching, diffractive optical components, or any other suitable applications.

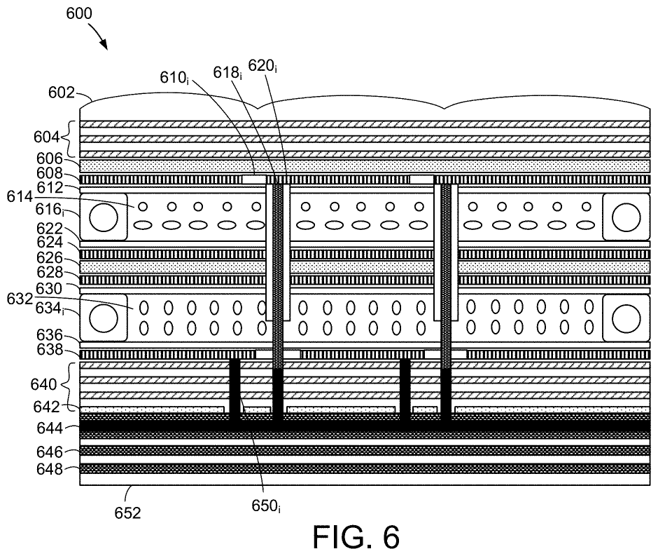

FIG. 6 is a schematic diagram illustrating a cross-section view of an exemplar liquid crystal on silicon (LCOS) optical patterning system 600, according to various embodiments. The optical patterning system 600 is a reflective, non-resonant complex SLM that includes an amplitude control layer and a phase control layer. All or some of the components shown in FIG. 6 may be in physical contact with one another, optically in contact with one another, have index matching fluid or optical glue between one another, and/or may have space therebetween.

As shown, the optical patterning system 600 includes an optional cover layer 602 that includes a microlens array, an anti-reflection layer 604, a polarizer 606 (e.g., a horizontal polarizer), a pixelated electrode 608, a LC layer 614 that includes spacers 6161 (collectively referred to as spacers 616 and individually referred to as a spacer 616) that maintain a thickness of the LC layer 614, alignment layers 612 and 622 that align the orientations of LC molecules within the LC layer 614, a common electrode 624, another polarizer 626 (e.g., a vertical polarizer), another common electrode 628, another LC layer 632 that includes spacers 634ᵢ (collectively referred to as spacers 634 and individually referred to as a spacer 634) that maintain a thickness of the LC layer 632, alignment layers 630 and 636 that align the orientations of LC molecules within the LC layer 632, another pixelated electrode 638, as well as a substrate 652, a high-reflection layer 640 that includes an optional metal reflector 642, an electronic bus bar 644, and optional other electronics circuitry layers 646 and 648. Each of the anti-reflection layer 604 and the high-reflection layer 640, which are also sometimes referred to as an antireflective coating and a highly-reflective coating, respectively, includes one or more layers of different materials that achieve a desired reflectivity/transmission property of light and can be collectively considered as a single functional layer.

In some embodiments, sections of the LC layer 614 in each cell are individually addressable by driving voltages using the pixelated electrode 608 and corresponding vias 618ᵢ (collectively referred to as vias 618 and individually referred to as a via 618) that are surrounded by insulating material 620ᵢ (collectively referred to as insulating material 620 and individually referred to as an insulating material 620). Driving a voltage can generate an electric field that reorients LC molecules in a section of the LC layer 614 within a cell, thereby changing a refractive index with respect to light passing through that section of the LC layer 614. For example, the state in which a voltage is being applied could be an “ON” state for the cell, and the state in which no voltage is being applied could be an “OFF” state for the cell, or vice versa. In some embodiments, in-between states may also be generated by applying a smaller voltage to partially reorient LC molecules. Although described herein primarily with respect to reorienting LC molecules using electric fields, magnetic fields may be used in lieu of electric fields to reorient LC molecules in other embodiments.

As shown, the pixelated electrode 608 is separated by dielectrics 610ᵢ (collectively referred to as dielectrics 610 and individually referred to as a dielectric 610) that electrically isolate the electrode associated with each cell. Accordingly, sections of the LC 614 in each cell are individually addressable by driving voltages using a corresponding electrode and via 618. Similarly, sections of the LC layer 632 in each cell are individually addressable by driving voltages using the pixelated electrode 638 that is separated by dielectrics and corresponding vias 650ᵢ (collectively referred to as vias 650 and individually referred to as a via 650). In contrast to the pixelated electrodes 608 and 638, the common electrode 624 is not separated across cells and functions as a common ground that separates voltages across the sections of the LC layer 614 and the LC layer 632 in each cell. Some embodiments of reflective (and transmissive) optical patterning systems that have more than two LC layers may include a common electrode between each LC layer, as well as vias that connect sections of those LC layers in each cell to circuitry included in a substrate.

In some embodiments, the LC layer 614 includes a twisted-nematic (TN) LC having LC molecules that are aligned via the alignment layers 612 and 622. More generally, the LC layer 614 can include any suitable LC in some embodiments, such as a TN LC or variation thereof (e.g., a super-twisted nematic LC), a vertically aligned LC, a parallel aligned LC, etc. having molecules that are aligned via alignment layers. In some embodiments, the alignment layers 612 and 622 are microstructure alignment layers that include structured gratings (e.g., subwavelength gratings) and can be fabricated via a scalable nano-fabrication technique, such as a lithography technique. In some embodiments, the polarizers 606 and 626 are linear polarizers that are aligned in orthogonal directions with respect to each other.

In operation, light that is incident on the optical patterning system 600 is linearly polarized by the polarizer 606, and, in some embodiments in which the LC layer 614 includes a TN LC, the linearly polarized light is either rotated or not rotated by a section of the LC layer 614 in each cell of the optical patterning system 600, depending on how that section of the LC layer 614 is being driven. Depending on the rotation of the linearly polarized light, an amplitude of the light is then attenuated, or not attenuated, by the polarizer 626. In other embodiments, the section of the LC layer 614 in a cell may control the phase of light passing through the cell, rather than rotating the polarization of the light.

Light whose amplitude has been attenuated, or not attenuated, further passes through the section of the LC layer 632 in the cell, which can be driven to impart an optical path length delay/phase change to the light. The LC layer 632 can include any suitable LC in some embodiments, such as a TN LC or variation thereof (e.g., a super-twisted nematic LC), a vertically aligned LC, a parallel aligned LC, etc. that is controllable to modulate a phase of light passing through the LC layer 632. The light that has passed through the LC layer 632 is then reflected, by the high-reflection layer 640 that includes the metal reflector 642, back through the LC layer 632, the polarizer 626, the LC layer 614, and the polarizer 606, which can further modulate the amplitude and/or phase of the reflected light. Accordingly, a spatially varying amplitude and phase modulation can be achieved.

In some embodiments, the microlens array included in the optional cover layer 602 is used to focus light through the LC layers 614 and 632 in order to improve performance. For example, the microlens array could be used to focus light so as to reduce the impact of discontinuities between the boundaries of neighboring pixels within the optical patterning system 600.

Components of the optical patterning system 600 may be constructed from any technically feasible materials and have any suitable size. For example, the microlens array cover layer 602 could be constructed from SiO₂, one or more layers within the anti-reflection layer 604 and the high-reflection layer 640 could be constructed from Nb₂O₅ and SiO₂, the pixelated electrodes 608 and 638 and the common electrode 628 could be constructed from ITO, the metal reflector 642 could be constructed from Al, the electronic bus bar 644 could be constructed from Cu, the other electronics circuitry layers 646 and 648 could be constructed from SiCN, the substrate 652 could be constructed from SiO₂, the vias 618 could be constructed from Al (or Cu), the insulating material 620 could be constructed from SiO₂, the dielectrics 610 could be constructed from HfO₂, and the spacers 616 and 634 could be constructed from microbeads, such as glass microbeads.

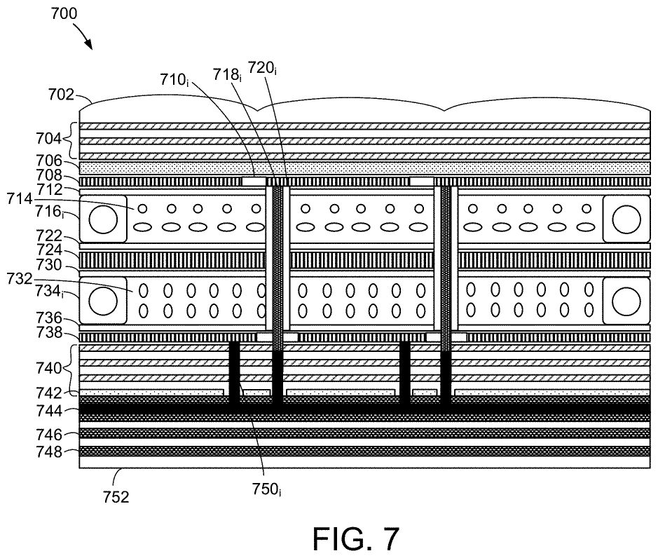

FIG. 7 is a schematic diagram illustrating a cross-section view of an exemplar LCOS optical patterning system 700, according to other various embodiments. The optical patterning system 700 is a reflective, non-resonant complex SLM that includes two cross-polarization phase control layers. All or some of the components shown in FIG. 7 may be in physical contact with one another, optically in contact with one another, have index matching fluid or optical glue between one another, and/or may have space therebetween.

As shown, the optical patterning system 700 includes an optional cover layer 702 that includes a microlens array, an anti-reflection layer 704, a polarizer 706 (e.g., a 45 degree linear polarizer), a pixelated electrode 708 separated by dielectrics 710ᵢ (collectively referred to as dielectrics 710 and individually referred to as a dielectric 710), a LC layer 714 that includes spacers 716ᵢ (collectively referred to as spacers 716 and individually referred to as a spacer 716), alignment layers 712 and 722 that align the orientations of LC molecules within the LC layer 714, a common electrode 724, another LC layer 732 that includes spacers 734ᵢ (collectively referred to as spacers 734 and individually referred to as a spacer 734), alignment layers 730 and 736 that align the orientations of LC molecules within the LC layer 732, another pixelated electrode 738, as well as a substrate 752, a high-reflection layer 740 that includes an optional metal reflector 742, an electronic bus bar 744, and optional other electronics circuitry layers 746 and 748.

The components of the optical patterning system 700 are similar to corresponding components of the optical patterning system 600 described above in conjunction with FIG. 6, except the optical patterning system 700 includes a single polarizer 706, rather than two polarizers. In some embodiments, the polarizer 706 polarizes light to be orthogonal to the operation polarization of the LC layers 714 and 732, which are also orthogonal. For example, if the LC layers 714 and 732 controlled the phase of horizontally and vertically polarized light, respectively, then the polarizer 706 could be set to be 45 or 135 degrees polarized or circularly polarized. In operation, the phase of one polarization component of the light that has been polarized by the polarizer 706 can be modulated (or not) by a segment of the LC layer 714 in a cell, depending on how that segment is being driven. For example, the segment of the LC layer 714 in the cell could be controlled to impart a phase delay to horizontally polarized light. In addition, the phase of another, orthogonal polarization component of the linearly polarized light can be modulated (or not) by a segment of the LC layer 732 in the cell, depending on how that segment is being driven. For example, the segment of the LC layer 732 in the cell could be controlled to impart a phase delay to vertically polarized light. Segments of the LC layer 714 are individually addressable using the pixelated electrode 708 and corresponding vias 718ᵢ (collectively referred to as vias 718 and individually referred to as a via 718) that are surrounded by insulating material 720ᵢ (collectively referred to as insulating material 720 and individually referred to as an insulating material 720), which are similar to the pixelated electrode 608 and vias 618, respectively, that are described above in conjunction with FIG. 6. Similarly, segments of the LC layer 732 are individually addressable using the pixelated electrode 738 and corresponding vias 750ᵢ (collectively referred to as vias 750 and individually referred to as a via 750).

The light that has passed through the LC layer 732 is then reflected, by the high-reflection layer 740 that includes the metal reflector 742, back through the LC layers 732 and 714, which can further modulate phases of different polarizations of the reflected light, and the polarizer 706. Depending on a difference between the phases of the two polarization components that have been modulated (or not) via the LC layers 714 and 732 and are passed through the polarizer 706, an amplitude of the light that exits the optical patterning system 700 can be attenuated (or not). Accordingly, a spatially varying amplitude and phase modulation can be achieved.

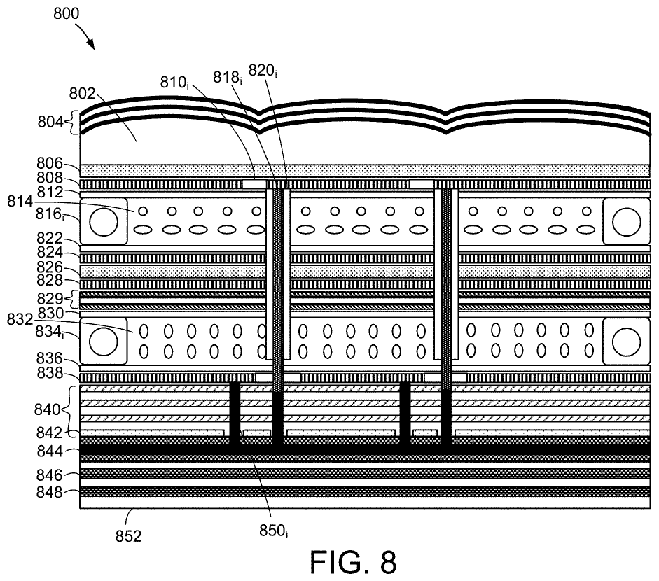

FIG. 8 is a schematic diagram illustrating a cross-section view of an exemplar LCOS optical patterning system 800, according to other various embodiments. The optical patterning system 800 is a reflective, resonant complex SLM that includes an amplitude control layer and a phase control layer. All or some of the components shown in FIG. 8 may be in physical contact with one another, optically in contact with one another, have index matching fluid or optical glue between one another, and/or may have space therebetween.

As shown, the optical patterning system 800 includes an optional cover layer 602 that includes a microlens array, an anti-reflection layer 804, a polarizer 806, a pixelated electrode 808 that is separated by dielectrics 810ᵢ (collectively referred to as dielectrics 810 and individually referred to as a dielectric 810), a LC layer 814 that includes spacers 816ᵢ (collectively referred to as spacers 816 and individually referred to as a spacer 816), alignment layers 812 and 822 that align the orientations of LC molecules within the LC layer 814, vias 818ᵢ (collectively referred to as vias 818 and individually referred to as a via 818) that are surrounded by insulating material 820ᵢ (collectively referred to as insulating material 820 and individually referred to as an insulating material 820), a common electrode 824, another polarizer 826, another common electrode 828, a partial-reflection layer 829, another LC layer 832 that includes spacers 834ᵢ (collectively referred to as spacers 834 and individually referred to as a spacer 834), alignment layers 830 and 836 that align the orientations of LC molecules within the LC layer 832, another pixelated electrode 838, as well as a substrate 852, a high-reflection layer 840 that includes an optional metal reflector 842, an electronic bus bar 844, and optional other electronics circuitry layers 846 and 848. The partial-reflection layer 829, which is also sometimes referred to as a partially-reflective coating, includes one or more layers of different materials that achieve a desired reflectivity/transmission property of light and can be collectively considered as a single functional layer. In some embodiments, the partial reflection layer 829 may be constructed from any technically feasible materials and have any suitable size and spatial features (such as periodic holes, surface contours, etc.). For example, the partial reflection layer 829 could include one or more layers that are constructed from Nb₂O₅ and SiO₂.

The components of the optical patterning system 800 are similar to corresponding components of the optical patterning system 800 described above in conjunction with FIG. 6, except the optical patterning system 800 includes the partial reflection layer 829 that, together with the high-reflection layer 840 that includes the metal reflector 842, create a cavity in which light bounces back and forth between the partial reflection layer 829 and the high-reflection layer 840 before exiting via the partial reflection layer 829, thereby enhancing interaction of the light with the LC layer 830 that is used to modulate the phase of light. The enhanced interaction permits the LC layer 830 to be thinner, while imparting the same effective change in the phase of light, because there are multiple paths to accumulate the phase change. In addition, a resonance structure can be used to produce a larger range of phase changes in some embodiments.

Although FIG. 8 is described with respect to resonance in a phase control layer, some embodiments may produce resonance in an amplitude control layer in addition to, or in lieu of, resonance in a phase control layer. For example, in some embodiments, the anti-reflection layer 804 may be replaced with a partial-reflection layer to create a resonant cavity that enhances the interaction of light with an amplitude control layer.

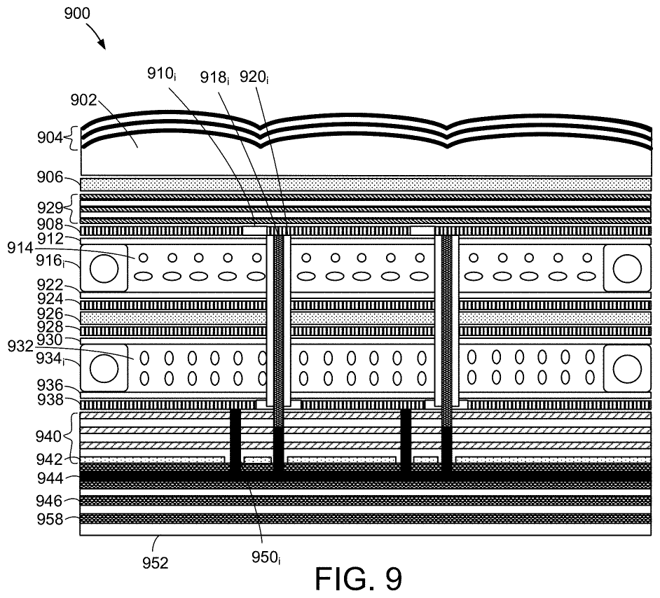

FIG. 9 is a schematic diagram illustrating a cross-section view of a LCOS optical patterning system 900, according to other various embodiments. The optical patterning system 900 is a reflective, resonant complex SLM that includes two cross-polarization phase control layers. All or some of the components shown in FIG. 9 may be in physical contact with one another, optically in contact with one another, have index matching fluid or optical glue between one another, and/or may have space therebetween.

As shown, the optical patterning system 900 includes an optional cover layer 902 that includes a microlens array, an anti-reflection layer 904, a polarizer 906, a partial reflection layer 929, a pixelated electrode 908 that is separated by dielectrics 910ᵢ (collectively referred to as dielectrics 910 and individually referred to as a dielectric 910), a LC layer 914 that includes spacers 916ᵢ (collectively referred to as spacers 916 and individually referred to as a spacer 916), alignment layers 912 and 922 that align the orientations of LC molecules within the LC layer 914, vias 918ᵢ (collectively referred to as vias 918 and individually referred to as a via 918) that are surrounded by insulating material 920ᵢ (collectively referred to as insulating material 920 and individually referred to as an insulating material 920), a common electrode 924, another LC layer 932 that includes spacers 934ᵢ (collectively referred to as spacers 934 and individually referred to as a spacer 934), alignment layers 930 and 936 that align the orientations of LC molecules within the LC layer 932, another pixelated electrode 938, as well as a substrate 952, a high-reflection layer 940 that includes an optional metal reflector 942, an electronic bus bar 944, and optional other electronics circuitry layers 946 and 948.

The components of the optical patterning system 900 are similar to corresponding components of the optical patterning system 600 described above in conjunction with FIG. 6, except the optical patterning system 900 only includes a single polarizer 906, rather than two polarizers, the optical patterning system 900 includes two cross-polarization phase control LC layers 914 and 932, and the optical patterning system 900 also includes the partial reflection layer 929, which is similar to the partial reflection layer 829 described above in conjunction with FIG. 8. In operation, the partial reflection layer 926 causes light to bounce back and forth within a cavity between the partial reflection layer 929 and the high-reflection layer 940 that includes the metal reflector 942, before exiting via the partial reflection layer 929. Doing so enhances the interaction of the light with the LC layers 914 and 932, which in some embodiments act as two cross-polarization phase control layers that can be used to modulate the phases of two orthogonal polarization components of light (in a spatially varying manner).

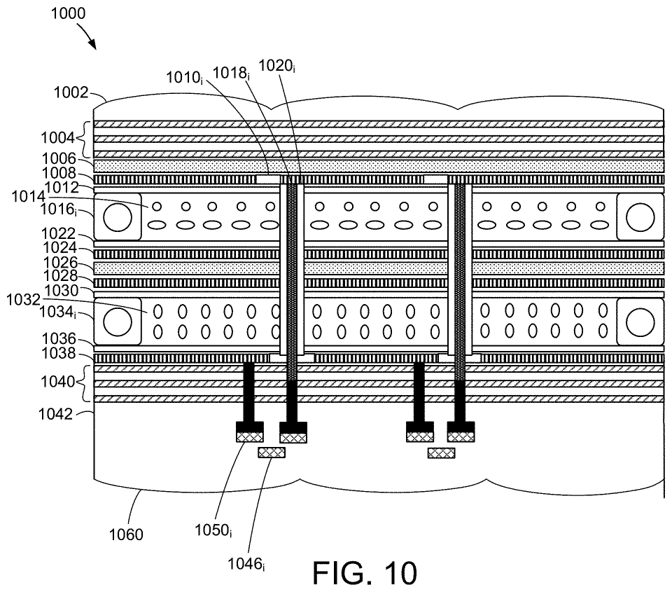

FIG. 10 is a schematic diagram illustrating a cross-section view of a transmissive optical patterning system 1000, according to various embodiments. The optical patterning system 1000 is a transmissive, non-resonant complex SLM that includes an amplitude control layer and a phase control layer. All or some of the components shown in FIG. 10 may be in physical contact with one another, optically in contact with one another, have index matching fluid or optical glue between one another, and/or may have space therebetween.

As shown, the optical patterning system 1000 includes an optional cover layer 1002 that includes a microlens array, an anti-reflection layer 1004, a polarizer 1006 (e.g., a horizontal polarizer), a pixelated electrode 1008 that is separated by dielectrics 1010ᵢ (collectively referred to as dielectrics 1010 and individually referred to as a dielectric 1010), a LC layer 1014 that includes spacers 1016ᵢ (collectively referred to as spacers 1016 and individually referred to as a spacer 1016), alignment layers 1012 and 1022 that align the orientations of LC molecules within the LC layer 1014, vias 1018ᵢ (collectively referred to as vias 1018 and individually referred to as a via 1018) that are surrounded by insulating material 1020ᵢ (collectively referred to as insulating material 1020 and individually referred to as an insulating material 1020) a common electrode 1024, another polarizer (e.g., a vertical polarizer 1026), another LC layer 1032 that includes spacers 1034ᵢ (collectively referred to as spacers 1034 and individually referred to as a spacer 1034), alignment layers 1030 and 1036 that align the orientations of LC molecules within the LC layer 1032, another pixelated electrode 1038, another anti-reflection layer 1040, a substrate 1042, optional other electronics circuitry layers 1046, and an additional optional cover layer 1060 that includes a microlens array.

The components of the optical patterning system 1000 are similar to corresponding components of the optical patterning system 600 described above in conjunction with FIG. 6, except the optical patterning system 1000 includes optically transparent materials on both sides of the system 1000 (rather than an opaque substrates), the anti-reflection layer 1040 rather than a high-reflection layer, the additional microlens array cover layer 1060, and wires 1046 and 1050 that, in some embodiments, come out from a side of the optical patterning system 1000 and connect with an electronic bus. In some embodiments, the optically transparent material and the microlens array cover layer 1060 may be constructed from SiO₂ or glass, the anti-reflection layer 1040 may include one or more layers that are constructed from Nb₂O₅ and SiO₂, and the wires 1046 and 1050 may be constructed from SiCN, or from any other technically feasible materials. In operation, light that is incident on the optical patterning system 1000 passes through the layers of the optical patterning system 1000, which is controllable to modulate an amplitude and/or a phase of the light (in a spatially varying manner). Then, the modulated light exits from another side of the optical patterning system 1000, rather than being reflected back through the optical patterning system 1000 and exiting from a same side that the light entered.

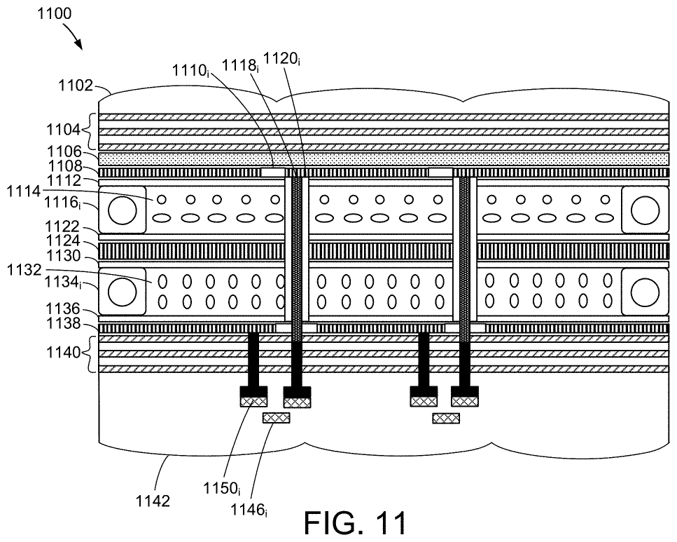

FIG. 11 is a schematic diagram illustrating a cross-section view of a transmissive optical patterning system 1100, according to other various embodiments. The optical patterning system 1100 is a transmissive, non-resonant complex SLM that includes two cross-polarization phase control layers. All or some of the components shown in FIG. 11 may be in physical contact with one another, optically in contact with one another, have index matching fluid or optical glue between one another, and/or may have space therebetween.

As shown, the optical patterning system 1100 includes an optional cover layer 1102 that includes a microlens array, an anti-reflection layer 1104, a polarizer 1106 (e.g., a 45 degree polarizer), a pixelated electrode 1108 that is separated by dielectrics 1110ᵢ (collectively referred to as dielectrics 1110 and individually referred to as a dielectric 1110), a LC layer 1114 that includes spacers 1116ᵢ (collectively referred to as spacers 1116 and individually referred to as a spacer 1116), alignment layers 1112 and 1122 that align the orientations of LC molecules within the LC layer 1114, vias 1118ᵢ (collectively referred to as vias 1118 and individually referred to as a via 1118) that are surrounded by insulating material 1120ᵢ (collectively referred to as insulating material 1120 and individually referred to as an insulating material 1120), a common electrode 1124, another LC layer 1132 that includes spacers 1134ᵢ (collectively referred to as spacers 1134 and individually referred to as a spacer 1134), alignment layers 1130 and 1136 that align the orientations of LC molecules within the LC layer 1132, another pixelated electrode 1138, another anti-reflection layer 1140, optional other electronics circuitry 1146, and an additional optional cover layer 1160 that includes a microlens array.

The components of the optical patterning system 1100 are similar to corresponding components of the optical patterning systems 700 and 1000 described above in conjunction with FIGS. 7 and 10. However, unlike the optical patterning system 700 (and like the optical patterning system 1000), the optical patterning system 1100 is transmissive. In operation, light that is incident on the optical patterning system 1100 passes through the layers of the optical patterning system 1100, which is controllable to modulate the phases of two orthogonally polarized components of the light (in a spatially varying manner), and the modulated light exits from another side of the optical patterning system 1100, rather than being reflected back through the optical patterning system 1100 and exiting from a same side that the light entered.

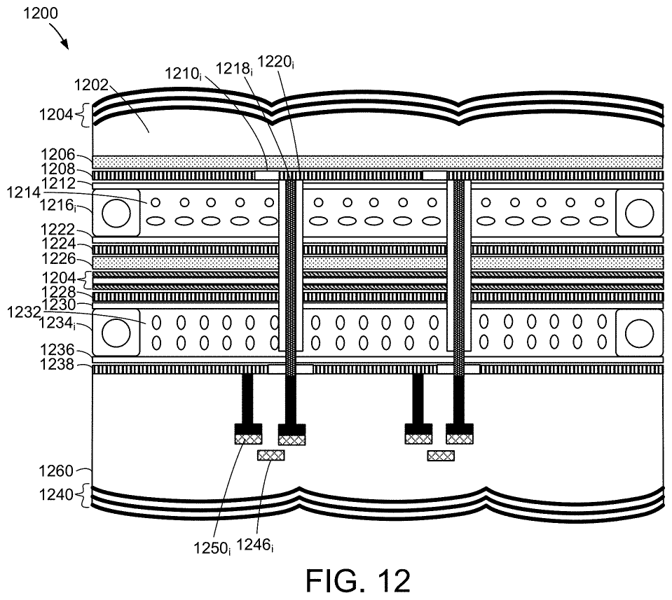

FIG. 12 is a schematic diagram illustrating a cross-section view of a transmissive optical patterning system 1200, according to other various embodiments. The optical patterning system 1200 is a transmissive, resonant complex SLM that includes an amplitude control layer and a phase control layer. All or some of the components shown in FIG. 12 may be in physical contact with one another, optically in contact with one another, have index matching fluid or optical glue between one another, and/or may have space therebetween.

As shown, the optical patterning system 1200 includes an optional cover layer 1202 that includes a microlens array, an anti-reflection layer 1204, a polarizer 1206 (e.g., a horizontal polarizer), a pixelated electrode 1208 that is separated by dielectrics 1210ᵢ (collectively referred to as dielectrics 1210 and individually referred to as a dielectric 1210), a LC layer 1214 that includes spacers 1216ᵢ (collectively referred to as spacers 1216 and individually referred to as a spacer 1216), alignment layers 1212 and 1222 that align the orientations of LC molecules within the LC layer 1214, vias 1218ᵢ (collectively referred to as vias 1218 and individually referred to as a via 1218) that are surrounded by insulating material 1220ᵢ (collectively referred to as insulating material 1220 and individually referred to as an insulating material 1220), a common electrode 1224, another polarizer 1226 (e.g., a vertical polarizer), a partial-reflection layer 1229, another LC layer 1232 that includes spacers 1234i (collectively referred to as spacers 2134 and individually referred to as a spacer 1234), alignment layers 1230 and 1236 that align the orientations of LC molecules within the LC layer 1232, another pixelated electrode 1238, another partial-reflection layer 1240, optional other electronics circuitry layers 1246, and an additional optional cover layer 1260 that includes a microlens array.

The components of the optical patterning system 1200 are similar to corresponding components of the optical patterning systems 800 and 1000 described above in conjunction with FIGS. 8 and 10. However, unlike the optical patterning system 800 (and like the optical patterning system 1000), the optical patterning system 1200 is transmissive. In addition, the optical patterning system 1200 includes the partial-reflection layer 1240 that creates a cavity in which light bounces back and forth between the partial-reflection layer 1240 and the partial-reflection layer 1229, thereby enhancing the interaction with the phase control LC layer 1232. Similar to the partial-reflection layer 829, described above in conjunction with FIG. 8, each of the partial-reflection layers 1229 and 1240 includes one or more layers of different materials that achieve a desired reflectivity/transmission property of light and can be collectively considered as a single functional layer. In some embodiments, the partial-reflection layers 1229 and 1240 may be constructed from any technically feasible materials and have any suitable size and spatial features (such as periodic holes, surface contours, etc.). For example, each of the partial-reflection layers 1229 and 1240 could include one or more layers that are constructed from Nb₂O₅ and SiO₂. In operation, light that is incident on the optical patterning system 1200 passes through the layers of the optical patterning system 1200, which are controllable to modulate the amplitude and/or phase of the light (in a spatially varying manner), and the modulated light exits from another side of the optical patterning system 1200, rather than being reflected back through the optical patterning system 1200 and exiting from a same side that the light entered.

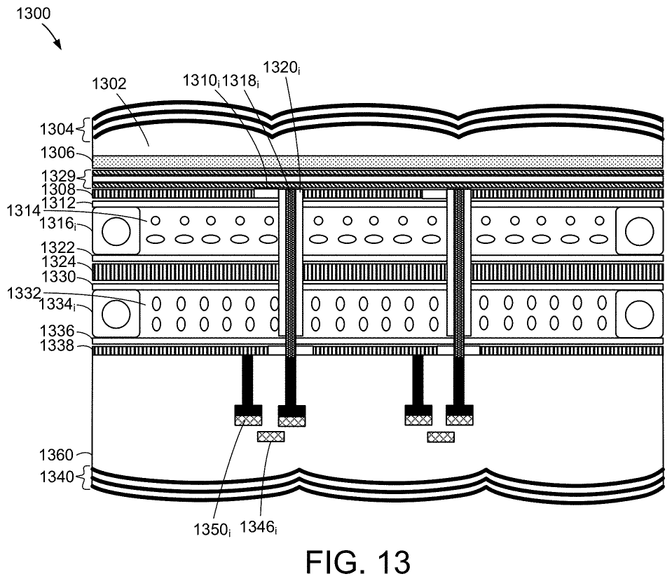

FIG. 13 is a schematic diagram illustrating a cross-section view of a transmissive optical patterning system 1300, according to other various embodiments. The optical patterning system 1300 is a transmissive, resonant complex SLM that includes two cross-polarization phase control layers. All or some of the components shown in FIG. 13 may be in physical contact with one another, optically in contact with one another, have index matching fluid or optical glue between one another, and/or may have space therebetween.

As shown, the optical patterning system 1300 includes an optional cover layer 1302 that includes a microlens array, an anti-reflection layer 1304, a polarizer 1306, a partial-reflection layer 1329, a pixelated electrode 1308 that is separated by dielectrics 1310ᵢ (collectively referred to as dielectrics 1310 and individually referred to as a dielectric 1310), a LC layer 1314 that includes spacers 1316ᵢ (collectively referred to as spacers 1316 and individually referred to as a spacer 1316), alignment layers 1312 and 1322 that align the orientations of LC molecules within the LC layer 1314, vias 1318ᵢ (collectively referred to as vias 1318 and individually referred to as a via 1318) that are surrounded by insulating material 1320ᵢ (collectively referred to as insulating material 1320 and individually referred to as an insulating material 1320), a common electrode 1324, another LC layer 1332 that includes spacers 1334i (collectively referred to as spacers 1334 and individually referred to as a spacer 1334), alignment layers 1330 and 1336 that align the orientations of LC molecules within the LC layer 1332, another pixelated electrode 1338, another partial-reflection layer 1340, an electronic bus bar 1344, optional other electronics circuitry layers 1346 and 1348, and an additional optional cover layer 1360 that includes a microlens array.

The components of the optical patterning system 1300 are similar to corresponding components of the optical patterning systems 900 and 1200 described above in conjunction with FIGS. 9 and 12. However, unlike the optical patterning system 900 (and like the optical patterning system 1200), the optical patterning system 1200 is transmissive. In addition, the optical patterning system 1300 includes the partial-reflection layer 1340 that creates a cavity in which light bounces back and forth between the partial-reflection layer 1340 and the partial-reflection layer 1329, thereby enhancing the interaction with the two cross-polarization phase control LC layers 1314 and 1332. In some embodiments, the partial-reflection layers 1329 and 1340 include one or more layers constructed from Nb₂O₅ and SiO₂, or any other technically feasible material, and have any suitable size and spatial features (such as periodic holes, surface contours, etc.). In operation, light that is incident on the optical patterning system 3200 passes through the layers of the optical patterning system 1300, which are controllable to modulate the phases of orthogonally polarized components of the light (in a spatially varying manner), and the modulated light exits from another side of the optical patterning system 1300, rather than being reflected back through the optical patterning system 1300 and exiting from a same side that the light entered.

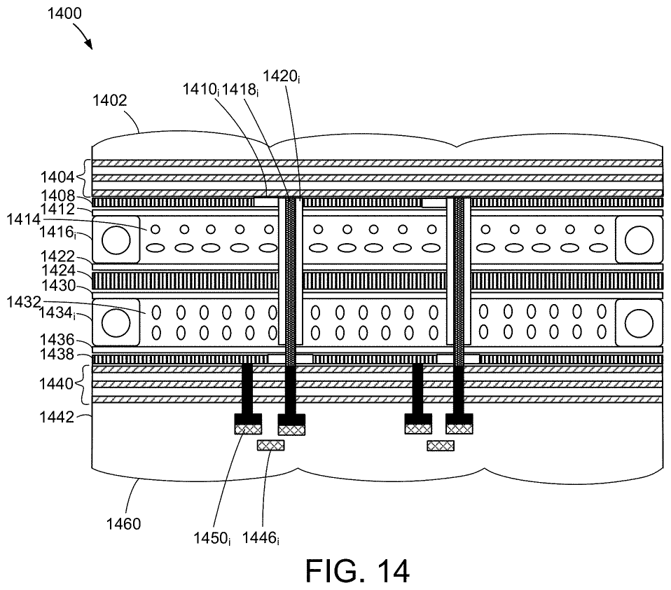

FIG. 14 is a schematic diagram illustrating a cross-section view of a transmissive optical patterning system 1400, according to other various embodiments. The optical patterning system 1400 is a transmissive, anisotropic active LC lens that is non-resonant and includes two cross-polarization phase control layers. All or some of the components shown in FIG. 14 may be in physical contact with one another, optically in contact with one another, have index matching fluid or optical glue between one another, and/or may have space therebetween.

As shown, the optical patterning system 1400 includes an optional cover layer 1402 that includes a microlens array, an anti-reflection layer 1404, a polarizer 1406, a pixelated electrode 1408 that is separated by dielectrics 1410ᵢ (collectively referred to as dielectrics 1410 and individually referred to as a dielectric 1410), a LC layer 1414 that includes spacers 1416ᵢ (collectively referred to as spacers 1416 and individually referred to as a spacer 1416), alignment layers 1412 and 1422 that align the orientations of LC molecules within the LC layer 1414, vias 1418ᵢ (collectively referred to as vias 1418 and individually referred to as a via 1418) that are surrounded by insulating material 1420ᵢ (collectively referred to as insulating material 1420 and individually referred to as an insulating material 1420), a common electrode 1424, another LC layer 1432 that includes spacers 1434ᵢ (collectively referred to as spacers 1434 and individually referred to as a spacer 1434), alignment layers 1430 and 1436 that align the orientations of LC molecules within the LC layer 1432, another pixelated electrode 1438, another anti-reflection layer 1440, a substrate 1442, an electronic bus bar 1444, optional other electronics circuitry layers 1446 and 1448, and an additional optional cover layer 1460 that includes a microlens array.

The components of the optical patterning system 1400 are similar to corresponding components of the optical patterning system 1100 described above in conjunction with FIG. 11, except the optical patterning system 1400 does not include a polarizer. In addition, in some embodiments, the geometry of the optical patterning system 1400 may include a lens with annular ring sections. In such cases, the optical patterning system 1400 can act as a transmissive, anisotropic active LC lens that is non-resonant and includes two cross-polarization layers that can control the phase of two orthogonal polarization components of light separately (in a spatially varying manner), while not modifying the amplitude of the light.

Although described herein primarily with respect to some embodiments in which the phases of different polarization components of light are controlled separately, in other embodiments, the amplitudes of different polarization components of light may be controlled separately. For example, in some embodiments, orthogonal polarization components of light may be spatially separated, after which amplitudes of those polarization components can be modulated and the polarization components combined together again.

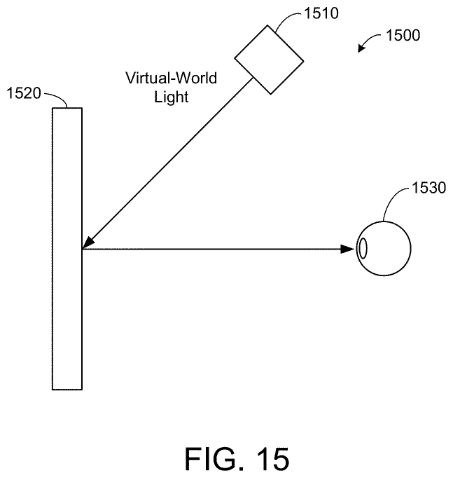

FIGS. 15-17 illustrate example optical system configurations that include one or more optical patterning systems, according to various embodiments. Such systems may be included in, for example, near-eye display devices for virtual reality (VR), augmented reality (AR), or mixed reality (MR), such as the NED system 100 or the HMD 162 described above with respect to FIGS. 1A-1B and 2A-2B, respectively. Although particular optical systems are disclosed herein as reference examples, the optical patterning systems disclosed herein may generally be included in any suitable optical systems. In various embodiments, an optical system for an AR, VR, and MR near-eye display device is configured to process virtual-world light, which is generated by a light source driven by an application (e.g., one of the applications stored in the application store 355 described above with respect to FIG. 3) executed by a computer processor. The optical system may process such virtual light to form an image at an exit pupil of the optical system, which may coincide with a location of an eye of a user of the NED device.

In various embodiments, an optical system for an AR and MR near-eye display device is configured to process real-world light. Unlike the case for virtual-world light, such an optical system need not introduce optical power to the image of the real-world light at the exit pupil and need not change the location of the exit pupil for the real-world light in response to a change in the location (and/or orientation) of the eye with respect to the optical system. Accordingly, real-world light and virtual-world light, though co-located in portions of the optical system, are, at least in some embodiments, processed differently from one another by the optical system.

FIG. 15 is a schematic diagram illustrating a portion of a virtual reality optical system 1500 that includes an optical patterning system, according to various embodiments. For example, the optical system 1500 could be included in a virtual reality NED. As shown, the optical system 1500 includes a light source 1510 and an optical patterning system 1520.

The light source 1510 is configured to project a beam of light onto the optical patterning system 1520. In some embodiments, the light source 1510 may include a coherent light source. Examples of coherent light sources include lasers and certain LEDS, sLEDs, and mLEDs, or some combination thereof. Any technically feasible light source may be used, and the type of light source that is used will generally depend on the application. For example, a coherent light source could be used to create holograms.

In some embodiments, the optical patterning system 1520 may be one of the reflective optical patterning systems described above with respect to FIGS. 4 and 6-9. For example, in some embodiments, the optical patterning system 1520 may be a spatial light modulator that can be driven to modulate coherent light emitted by the light source 1510 to form holograms. In other embodiments, the optical patterning system 1520 may be used in any suitable applications, such as video or image projection.

In some embodiments, the optical system 1500 may include additional components that are not shown, such as a lens or other optical element(s) that focus light at an exit pupil 1530 of the optical system 1500, an eye tracking module to provide eye position information to a controller module, optical element(s) to steer the exit pupil 1530 to different locations according to an eye gaze angle, etc. For example, a rift lens, PBP lens, pancake lens, etc. could be used to focus light at the exit pupil 1530. As another example, an eye tracking module could be located at any of a number of locations within or on a NED. That is, embodiments may include any technically feasible configuration of a VR optical system that includes an optical patterning system according to techniques disclosed herein.

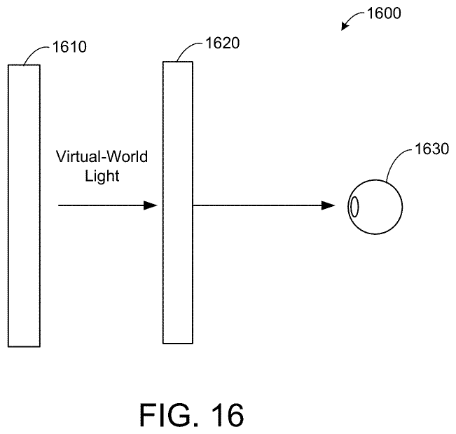

FIG. 16 is a schematic diagram illustrating a portion of another virtual reality optical system 1600 that includes an optical patterning system, according to various embodiments. For example, the optical system 1600 could be included in a virtual reality NED. As shown, the optical system 1600 includes a light source 1610 and an optical patterning system 1620.

Similar to the light source 1510 described above, the light source 1610 may include, e.g., a coherent light source such as a laser, LED, sLED, or mLED that projects a beam of light onto the optical patterning system 1620.

In contrast to the optical patterning system 1520, the optical patterning system 1620 transmits light incident thereon from the light source 1610. In some embodiments, the optical patterning system 1620 may be one of the transmissive optical patterning systems described above with respect to FIGS. 5 and 10-14. For example, in some embodiments, the optical patterning system 1620 may be a spatial light modulator that can be driven to modulate coherent light emitted by the light source 1610 to form holograms. In other embodiments, the optical patterning system 1620 may be used in any suitable applications, such as video or image projection.

Similar to the discussion above with respect to the optical system 1500, the optical system 1600 may include additional components that are not shown, such as a lens or other optical element(s) that focus light at an exit pupil 1630 of the optical system 1600, an eye tracking module to provide eye position information to a controller module, optical element(s) to steer the exit pupil 1630 to different locations according to an eye gaze angle, etc.

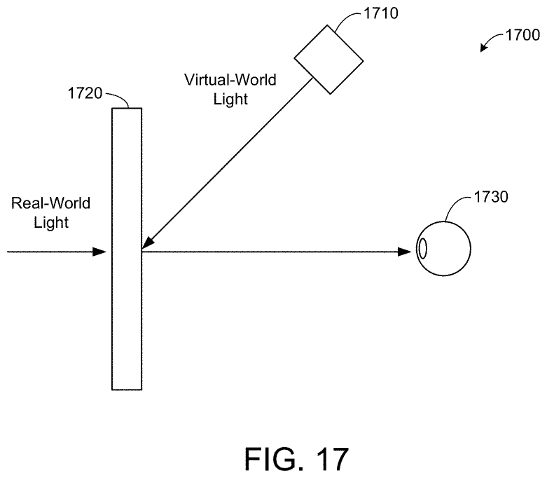

FIG. 17 is a schematic diagram illustrating a portion of an augmented reality optical system 1700 that includes an optical patterning system, according to various embodiments. For example, the optical system 1700 may be included in an augmented reality NED. The optical system 1700 is different from the optical systems 1500 and 1600 in a number of ways. For example, the optical systems 1500 and 1600 are configured to operate with virtual-world light, whereas the optical system 1700 is configured to operate with virtual-world light and real-world light.

As shown, the optical system 1700 includes a light source 1710 and an optical patterning system 1720. Similar to the light source 1510 described above, the light source 1710 may include, e.g., a coherent light source such as a laser, LED, sLED, or mLED that projects a beam of light onto the optical patterning system 1720.

Illustratively, the optical patterning system 1720 works in a reflective mode that is transparent to real-world light and combines the real-world light with a virtual image generated using the light source 1710. For example, in some embodiments, the optical patterning system 1720 may be similar to the reflective optical patterning systems described above with respect to FIGS. 4 and 6-9, except a reflective substrate and/or a high-reflection layer may be replaced by a transflective substrate and/or a layer that is partially reflective and partially transmissive. Similar to the description above with respect to the optical patterning system 1620, in some embodiments, the optical patterning system 1720 may be a spatial light modulator that can be driven to modulate coherent light emitted by the light source 1710 to form holograms. In other embodiments, the optical patterning system 1720 may be used in any suitable applications, such as video or image projection.

In some embodiments, the optical system 1700 may further include a prism, waveguide optical system, or other optical element(s) that redirect and/or focus light from the light source 1710 to the exit pupil position 1730. In such cases, an optical patterning system may (or may not) be located differently in the optical system than the optical patterning system 1720 shown in FIG. 10. In some embodiments, the optical system 1700 may also include other components that are not shown, such as a lens or other optical element(s) that focus light at an exit pupil 1730 of the optical system 1700, an eye tracking module to provide eye position information to a controller module, optical element(s) to steer the exit pupil 1730 to different locations according to an eye gaze angle, etc. That is, embodiments may include any technically feasible configuration of an AR optical system that includes an optical patterning system according to techniques disclosed herein.

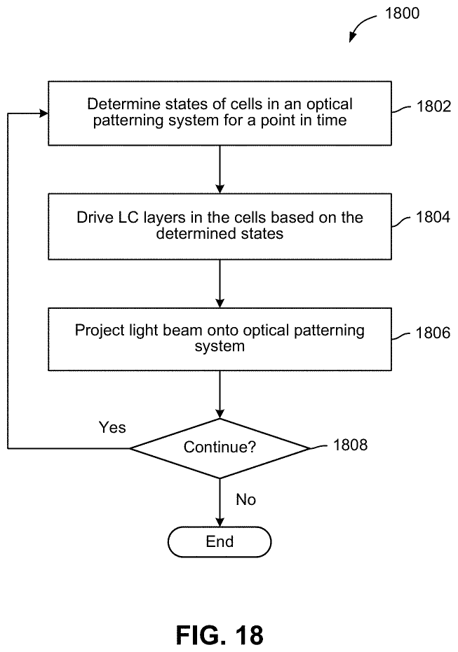

FIG. 18 is a flow diagram illustrating a method for modulating a beam of light, according to various embodiments. Although the method steps are described with reference to the systems of FIGS. 1-17, persons skilled in the art will understand that any system may be configured to implement the method steps, in any order, in other embodiments.

As shown, a method 1800 begins at step 1802, where an application determines the states of cells of an optical patterning system for a point in time. The application may be, e.g., one of the applications stored in the application store 355, which as described above with respect to FIG. 3 may include gaming applications, conferencing applications, video playback applications, or any other suitable applications. In some embodiments, the application may determine cells, or sections of LC layers within cells, of the optical patterning system to turn ON and OFF, and/or to turn to in-between states, at step 1802.

The state of each cell that is determined at step 1802 may include a state of multiple sections of LC layers within that cell that can be used to separately control different DOFs of light. Further, the states that are determined at step 1802 may generally depend on the dynamic optics application. For example, the application may solve holography equations to determine states for cells that are needed to generate a hologram from light emitted by a coherent light source. Any other suitable states may be determined for other dynamic optics applications.

At step 1804, the application causes sections of LC layers in cells of the optical patterning system to be driven based on the determined states. Doing so may reorient the anisotropic LC molecules within those sections of the LC layers. For example, the controller could determine drive voltages required to achieve the determined states and cause those voltages to be generated via electrodes.

At step 1806, the application causes a light beam to be projected onto the optical patterning system. In operation, the optical patterning system imposes a spatially varying modulation of different DOFs of the light beam. As a result, the optical patterning system may, e.g., be used to encode a coherent light beam from a light source with a pattern output to form holograms, as described above, or in any other suitable application. In some embodiments, such as the optical patterning systems described above with respect FIGS. 4 and 6-9, the optical patterning system may reflect the modulated light. In other embodiments, such as the optical patterning systems described above with respect to FIGS. 5 and 10-14, the optical patterning system may transmit the modulated light.

At step 1808, the application determines whether to continue to another point in time. If the application determines to continue, then the method 1800 returns to step 1802, where the application determines the states of cells in the optical patterning system for a next point in time. On the other hand, if the application determines not to continue, then the method 1800 ends.

### Techniques for Manufacturing Multi-Layer Liquid Crystal Active Light Modulation

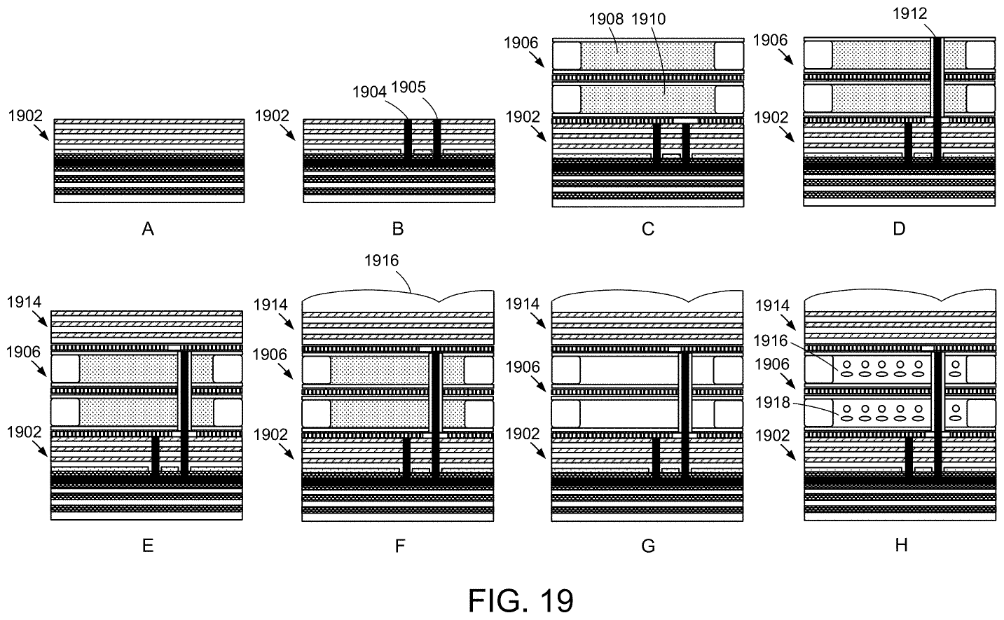

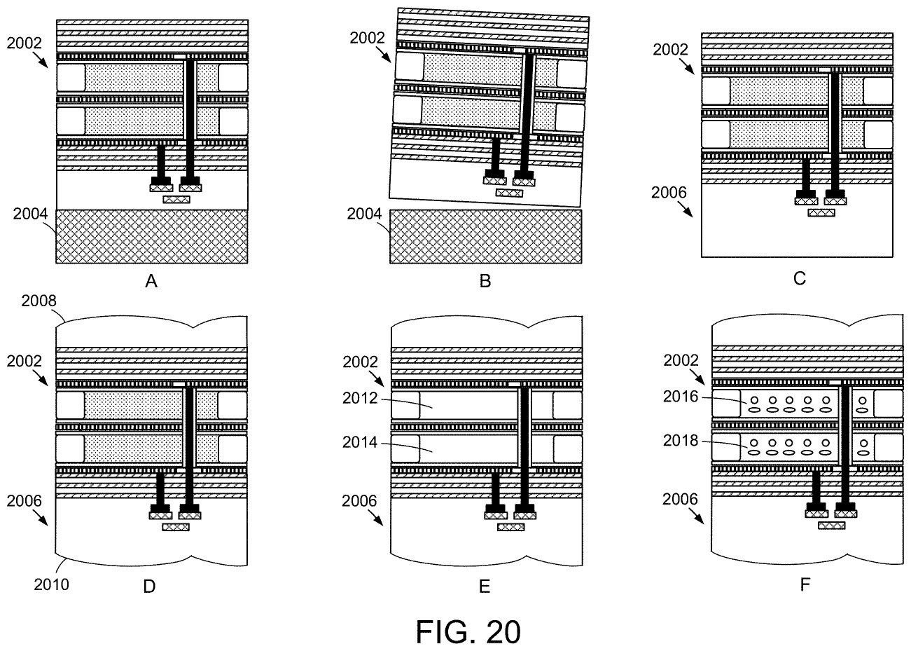

FIG. 19 illustrates an example approach for fabricating a dual-layer LCOS optical patterning system, according to various embodiments. In some embodiments, such as the examples shown in FIGS. 19-20, both the electronic and the photonics components of an optical patterning system can be fabricated using a conventional micro-fabrication processes that is scalable at the wafer level. In particular, in some embodiments, the optical patterning systems can be fabricated via a layer-by-layer, bottom-up approach. In such cases, each layer may be fabricated using deposition, patterning, etching, and/or polishing steps. Although optical patterning systems that include particular layers are shown in FIGS. 19-20 for illustrative purposes, optical patterning systems that include other layers may be fabricated in a similar manner in some embodiments.

As shown in panel A, a bottom stack 1902 that includes a substrate and circuitry is fabricated via, e.g., conventional complementary metal-oxide-semiconductor (CMOS) fabrication techniques, and a high-reflection layer is added on top of the substrate.

As shown in panel B, the bottom stack 1902 is etched through, and a first layer of electronic vias 1904 and 1905 is deposited through the top of the high-reflection layer on the bottom stack 1902.

As shown in panel C, a two-layer LC cell 1906 is fabricated on top of the bottom stack 1902. Illustratively, sacrificial material 1908 and 1910 is used to fill in spaces that will later be filled with LCs. For example, the sacrificial materials 1908 and 1910 could be glass or a polymer that can be etched away.

As shown in panel D, the layers of the LC cell 1906 are etched through, and a second layer of electronic vias 1912 is deposited that extends to the top layer of the LC cell 1906.

As shown in panel E, a top layer 1914 that includes an optical reflection layer, such as an anti-reflection layer, and electrode structures is fabricated above the LC cell 1906.

As shown in panel F, a cover layer 1916 that includes a microlens array is added on top of the top layer 1914. The microlens array cover layer 1916 can be added in any technically feasible manner. In some embodiments, the microlens array cover layer 1916 may be fabricated via, e.g., a grayscale lithography technique. In other embodiments, the microlens array cover layer 1916 may be laminated on top of the layer 1914.

As shown in panel G, the sacrificial material 1908 and 1910 within the LC cell 1906 is etched away. In some embodiments, the sacrificial material within each layer of LC cell 1906 is etched away separately, layer by layer. In other embodiments, the sacrificial material within multiple layers of the LC cell 1906 may be etched away at the same time.

As shown in panel H, spaces within the LC cell 1906, after the sacrificial material 1908 and 1910 has been etched away, are filled with LCs 1916 and 1918. The spaces within the LC cell 1906 can be filled with LCs 1916 and 1918 in any technically feasible manner. In some embodiments, the optical patterning system can be placed in a vacuum that sucks air out of the spaces within the LC cell 1906. Then, a LC can be placed on an edge of the optical patterning system, causing the LC to be sucked into the spaces within the LC cell 1906 by suction pressure resulting from the vacuum within those spaces. It should be understood that orientations of LC molecules within the LCs 1916 and 1918 will be determined by alignment layers on either side of the LCs 1916 and 1918. As described, in some embodiments, the alignment layers are microstructure alignment layers that include structured gratings (e.g., subwavelength gratings) and can be fabricated via a scalable nano-fabrication technique, such as a lithography technique. In such cases, fabricating the alignment layers may include patterning, and the alignment layers can be fabricated along with other layers of the optical patterning system.

FIG. 20 illustrates an example approach for fabricating a dual-layer transmissive optical patterning system, according to various embodiments. Similar to the description above in conjunction with FIG. 19, in some embodiments, a transmissive optical patterning systems can be fabricated via a layer-by-layer, bottom-up process on a wafer level. In such cases, each layer may be fabricated using deposition, patterning, etching, and/or polishing steps in a micro-fabrication processes.

As shown in panel A, layered structures 2002 are first fabricated on a silicon substrate 2004. In some embodiments, the layered structures 2002 can be fabricated in a manner similar to the approach described above in conjunction with panels A-E of FIG. 19. However, similar to the transmissive optical patterning systems 1000-1400 described above in conjunction with FIGS. 10-14 (and unlike the reflective optical patterning system described in conjunction with FIG. 19), the layered structures 2002 may not include a high-reflection layer. In some embodiments, the layered structures 2002 may instead include a partial-reflection layer or an antireflection layer.

As shown in panel B, the layered structures 2002 are released from the silicon substrate 2004. The layered structures 2002 can be released from the silicon substrate 2004 in any technically feasible manner, including using well-known lift off techniques.

As shown in panel C, the layered structures 2002 that have been released from the silicon substrate 2004 are bonded to a transparent substrate 2006, such as a substrate constructed from silicon dioxide or glass.

As shown in panel D, microlens array cover layers 2008 and 2010 are added to two sides of the layered structures 2002 that has been bonded to the transparent substrate 2006. In some embodiments, a transparent layer, such as a silicon dioxide or glass layer, may also be fabricated on top of the layered structures 2002 before the cover layer 2008 including the microlens array is added.

As shown in panel E, sacrificial material within a LC cell in the layered structures 2002 is etched away. Similar to the description above in conjunction with panel G of FIG. 19, the sacrificial material within each layer of the LC cell can be etched away separately in some embodiments. In other embodiments, the sacrificial material within multiple layers of the LC cell may be etched away at the same time.

As shown in panel F, spaces within the LC cell in the layered structures 2002, after the sacrificial material has been etched away, are filled with LCs 2016 and 2018. Similar to the description above in conjunction with panel H of FIG. 19, in some embodiments, the optical patterning system can be placed in a vacuum that sucks air out of the spaces within the LC cell after the sacrificial material has been etched away, and an LC that is placed on an edge of the system can be sucked into the spaces within the LC cell 1906 by suction pressure resulting from the vacuum within those spaces.

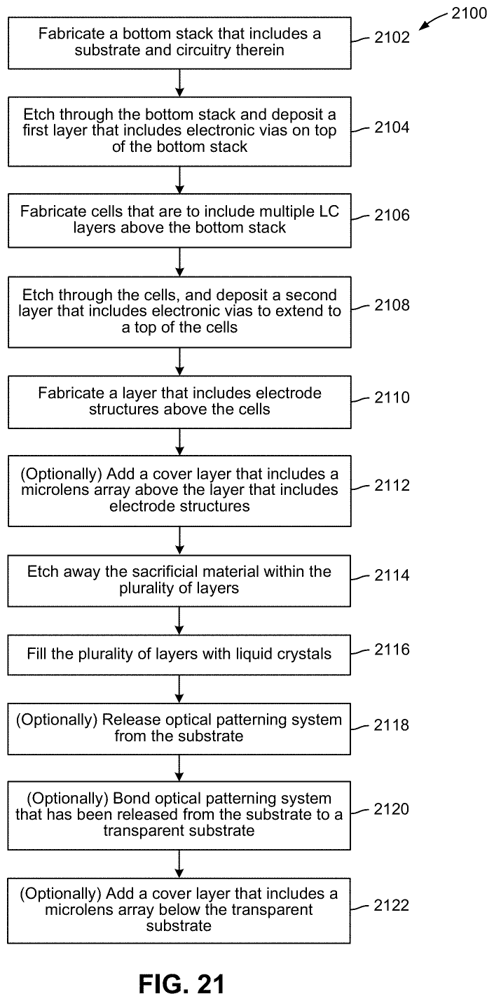

FIG. 21 is a flow diagram illustrating a method for fabricating an optical patterning system, according to various embodiments. Although the method steps are described with reference to the systems of FIGS. 1-17 and 19-20, persons skilled in the art will understand that any system may be configured to implement the method steps, in any order, in other embodiments.

As shown, a method 2100 begins at step 2102, where a bottom stack that includes a substrate and circuitry therein is fabricated. As described, the bottom stack can be fabricated via, e.g., conventional CMOS fabrication techniques in some embodiments. In some embodiments in which the optical patterning system is reflective, a high-reflection layer can be added on top of the substrate. In other embodiments, a partial-reflection layer or antireflection layer may be added rather than a high-reflection layer.

At step 2104, the bottom stack is etched through and a first layer that includes electronic vias is deposited on top of the bottom stack.

At step 2106, cells that are to include multiple LC layers are fabricated above the bottom stack. In some embodiments, the cells are initially fabricated to include layers that are filled with sacrificial material.

At step 2108, the cells are etched through, and a second layer that includes electronic vias is deposited to extend to a top of the cells.

At step 2110, a layer that includes electrode structures is fabricated above the cells. In some embodiments, the first and second layers that include electronic vias, and corresponding electrodes, permit two layers of LCs to be independently addressable along a direction that light propagates. In some embodiments in which the cells include more than two layers of LCs, an additional layer that includes electronic vias can be deposited, and an additional layer that includes electrode structures can be fabricated, for each additional LC layer.

At step 2112, a cover layer that includes a microlens array is optionally added above the layer that includes electrode structures. As described, the microlens array cover layer may be fabricated via, e.g., a grayscale lithography technique in some embodiments. In other embodiments, the microlens array cover layer may be laminated on top of the layer that includes electrode structures.

At step 2114, the sacrificial material within the plurality of layers is etched away. As described, the sacrificial material within each layer in the LC cell can be etched away separately, layer by layer, in some embodiments. In other embodiments, the sacrificial material within multiple layers of the LC cell may be etched away at the same time.

At step 2116, the plurality of layers are filled with liquid crystals. As described, in some embodiments, the optical patterning system can be placed in a vacuum that sucks air out of spaces within the LC cell after the sacrificial material has been etched away, and one or more LCs that are placed on an edge of the optical patterning system can be sucked into the spaces within the LC cell 1906 by suction pressure resulting from the vacuum within those spaces.

At step 2118, the optical patterning system is optionally released from the substrate. Step 2118 assumes that the optical patterning system is transmissive. In some embodiments, the optical patterning system can be released from the substrate in any technically feasible manner, including using well-known lift off techniques.

At step 2120, the optical patterning system that has been released from the substrate is bonded to a transparent substrate, such as a substrate constructed from silicon dioxide or glass.

At step 2122, a cover layer that includes a microlens array is added below the transparent substrate. Similar to step 2112, in some embodiments, the microlens array cover layer can be fabricated via, e.g., a grayscale lithography technique, or laminated to the transparent substrate.

One advantage of the optical patterning systems disclosed herein is that the systems can be more compact in size relative to conventional systems that include multiple SLMs relayed via an optical relay-imaging system or that laminate together multiple SLMs that include different substrates. In the optical patterning systems disclosed herein, multiple liquid crystal layers can be placed relatively close to one another, which reduces propagation effects of light passing through the optical patterning systems. Further, techniques are disclosed for achieving a relatively high fill factor by placing non-optically transparent electronic control circuits underneath the reflective materials in a reflective optical patterning system, and by using microlens arrays in reflective and transmissive optical patterning systems. In addition, some embodiments of the optical patterning systems disclosed herein can be fabricated using conventional micro-fabrication processes that are scalable at the wafer level, and no mutual alignment between layers of SLMs that are laminated together is required. These technical advantages represent one or more technological advancements over prior art approaches.

1. In some embodiments, an optical patterning system comprises a plurality of liquid crystal layers, and a substrate that includes circuitry, wherein each liquid crystal layer included in the plurality of liquid crystal layers is controllable to modulate a different degree of freedom of light, and wherein each liquid crystal layer included in the plurality of liquid crystal layers is connected to the circuitry included in the substrate.

2. The optical patterning system of clause 1, further comprising at least one microlens array.

3. The optical patterning system of clauses 1 or 2, wherein each liquid crystal layer included in the plurality of liquid crystal layers is connected by a separate set of vias to the circuitry included in the substrate.

4. The optical patterning system of any of clauses 1-3, wherein at least two of the plurality of liquid crystal layers share a common electrode.

5. The optical patterning system of any of clauses 1-4, further comprising at least one polarizer.

6. The optical patterning system of any of clauses 1-5, further comprising at least one of a high-reflection layer or a partial-reflection layer.

7. The optical patterning system of any of clauses 1-6, wherein the substrate includes either a nontransparent material or a transparent material.

8. The optical patterning system of any of clauses 1-7, wherein the plurality of liquid crystal layers is partitioned into rectangular or annular segments.

9. The optical patterning system of any of clauses 1-8, wherein the optical patterning system is used in computer-generated holography.

10. The optical patterning system of any of clauses 1-9, wherein the optical patterning system is included in a near eye display device.

11. In some embodiments, a method for fabricating an optical patterning system comprises fabricating a first stack that includes a substrate, circuitry, and at least one of a high-reflection layer, a partial-reflection layer, or an anti-reflection layer, etching through the first stack and depositing a first layer that includes electronic vias, fabricating at least one cell above the first stack, wherein each cell includes a plurality of layers that are filled with sacrificial material, etching through the at least one cell and depositing a second layer that includes electronic vias, fabricating a third layer that includes one or more electrodes above the at least one cell, etching away the sacrificial material within the plurality of layers, and filling the plurality of layers with liquid crystals.

12. The method of clause 11, further comprising fabricating a cover layer that includes a microlens array above the third layer using a lithography technique.

13. The method of clauses 11 or 12, further comprising laminating a cover layer that includes a microlens array above the third layer.

14. The method of any of clauses 11-13, wherein each cell further includes a plurality of alignment layers adjacent to the plurality of layers.

15. The method of any of clauses 11-14, wherein each of the plurality of alignment layers includes microstructure gratings that are fabricating using a lithography technique.

16. The method of any of clauses 11-15, further comprising releasing the optical patterning system from the substrate, and bonding the optical patterning system to a transparent substrate.

17. The method of any of clauses 11-16, further comprising fabricating a cover layer that includes a microlens array above the third layer, and fabricating a second cover layer that includes a microlens array below the transparent substrate.

18. In some embodiments, a computer-implemented method for modulating light comprises determining states of a plurality of cells of an optical patterning system for at least one point in time, driving each cell included in the plurality of cells based on a corresponding state, wherein driving the cell comprises driving, via a first connection to circuitry in a substrate, a section of a first liquid crystal layer to modulate at least a first degree of freedom of light, and driving, via a second connection to the circuitry in the substrate, a section of a second liquid crystal layer to modulate at least a second degree of freedom of light, and projecting a light beam that is incident on the plurality of cells.

19. The computer-implemented method of clause 18, further comprising passing the light beam through at least one microlens array.

20. The computer-implemented method of clauses 18 or 19, further comprising passing the light beam through at least one polarizer.

Any and all combinations of any of the claim elements recited in any of the claims and/or any elements described in this application, in any fashion, fall within the contemplated scope of the present disclosure and protection.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

The descriptions of the various embodiments have been presented for purposes of illustration, but are not intended to be exhaustive or limited to the embodiments disclosed. Many modifications and variations is apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It is understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An optical patterning system, comprising:
a plurality of liquid crystal layers; and
a substrate that includes circuitry,
wherein each liquid crystal layer included in the plurality of liquid crystal layers is controllable to modulate a different degree of freedom of light, and
wherein each liquid crystal layer included in the plurality of liquid crystal layers is connected to the circuitry included in the substrate.

2. The optical patterning system of claim 1, further comprising at least one microlens array.

3. The optical patterning system of claim 1, wherein each liquid crystal layer included in the plurality of liquid crystal layers is connected by a separate set of vias to the circuitry included in the substrate.

4. The optical patterning system of claim 1, wherein at least two of the plurality of liquid crystal layers share a common electrode.

5. The optical patterning system of claim 1, further comprising at least one polarizer.

6. The optical patterning system of claim 1, further comprising at least one of a high-reflection layer or a partial-reflection layer.

7. The optical patterning system of claim 1, wherein the substrate includes either a nontransparent material or a transparent material.

8. The optical patterning system of claim 1, wherein the plurality of liquid crystal layers is partitioned into rectangular or annular segments.

9. The optical patterning system of claim 1, wherein the optical patterning system is used in computer-generated holography.

10. The optical patterning system of claim 1, wherein the optical patterning system is included in a near eye display device.

11. A method for fabricating an optical patterning system, the method comprising:
fabricating a first stack that includes a substrate, circuitry, and at least one of a high-reflection layer, a partial-reflection layer, or an anti-reflection layer;
etching through the first stack and depositing a first layer that includes electronic vias;
fabricating at least one cell above the first stack, wherein each cell includes a plurality of layers that are filled with sacrificial material;
etching through the at least one cell and depositing a second layer that includes electronic vias;
fabricating a third layer that includes one or more electrodes above the at least one cell;
etching away the sacrificial material within the plurality of layers; and
filling the plurality of layers with liquid crystals.

12. The method of claim 11, further comprising fabricating a cover layer that includes a microlens array above the third layer using a lithography technique.

13. The method of claim 11, further comprising laminating a cover layer that includes a microlens array above the third layer.

14. The method of claim 11, wherein each cell further includes a plurality of alignment layers adjacent to the plurality of layers.

15. The method of claim 14, wherein each of the plurality of alignment layers includes microstructure gratings that are fabricating using a lithography technique.

16. The method of claim 11, further comprising:
releasing the optical patterning system from the substrate; and
bonding the optical patterning system to a transparent substrate.

17. The method of claim 16, further comprising:
fabricating a cover layer that includes a microlens array above the third layer; and
fabricating a second cover layer that includes a microlens array below the transparent substrate.

18. A computer-implemented method for modulating light, the method comprising:
determining states of a plurality of cells of an optical patterning system for at least one point in time;
driving each cell included in the plurality of cells based on a corresponding state, wherein driving the cell comprises:
driving, via a first connection to circuitry in a substrate, a section of a first liquid crystal layer to modulate at least a first degree of freedom of light, and
driving, via a second connection to the circuitry in the substrate, a section of a second liquid crystal layer to modulate at least a second degree of freedom of light; and
projecting a light beam that is incident on the plurality of cells.

19. The computer-implemented method of claim 18, further comprising passing the light beam through at least one microlens array.

20. The computer-implemented method of claim 18, further comprising passing the light beam through at least one polarizer.
